(19) United States
(12) Patent Application Publication
(10) Pub. No.: US 2008/0040758 A1
(43) Pub. Date: Feb. 14, 2008

(54) Media system and method for purchasing, downloading and playing media content

(76) Inventors: Todd Beetcher, Boulder, CO (US); Curt Bruner, Longmont, CO (US); Lance R. Carlson, Longmont, CO (US); David Feller, Longmont, CO (US)

Correspondence Address: PRITZKAU PATENT GROUP, LLC, 993 GAPTER ROAD, BOULDER, CO, 80303, US

(21) Appl. No.: 11/502,051

(22) Filed: Aug. 10, 2006

(51) Int. Cl. H04N 7/16; H04N 7/18

(52) U.S. Cl. 725/81; 725/138; 725/74; 725/78; 725/80

(57) ABSTRACT

Exemplary embodiments providing one or more improvements include a media system which connects to multiple media demodulation devices through a cable infrastructure and to a digital media content provider to allow a user to purchase, download and play media content by interacting with a remote control located at any given one of the media demodulation devices.

A media system which utilizes a building cable infrastructure to distribute media content to multiple media demodulation devices already connected to the cable infrastructure and which allows a user to purchase, download and play media content from the location of any of the media demodulation devices in the building without connecting additional hardware to each of the media demodulation devices.

### BACKGROUND

Entertainment and information media content is stored, distributed and used in many forms and formats of portable storage devices. Audio-visual media content, such as movies, are stored and distributed on digital video disks (DVDs) while compact discs (CDs) have become the standard in which to store and distribute music files. Magnetic and electronic storage devices such as disk drives and flash memories are also used for storing media content using formats such as MPEG, MP3 and others.

Along with the various media content storage and distribution devices comes a varied array of media content players. DVDs are typically played on dedicated DVD players connected to televisions or on DVD drives in computers where the media content is displayed on the computer screen. CDs can also be played on computers along with dedicated portable CD players and other audio stereo devices. MP3 and MPEG files can be played on computers and dedicated MP3 players are common today.

One problem that arises because of the different formats and storage devices for media content is that of having to own various types of media players to accommodate the different formats. It is now common for a house to have multiple televisions, with each television located in a different room of the house. In this situation, the user must decide which type of player to connect to which television. The user is then limited to experiencing the media content in the location where a player compatible with the media format type is located.

Another problem arises when the user has one type of media content that the user wants to play at different locations in the house. For example, playing media content from a DVD generally requires a DVD player to be connected to the television in the room where the DVD is going to be viewed. If the DVD is to be viewed in a second room, then another DVD player is connected to the television in that room, or the DVD player is moved from the first room to the second room where the player is connected to the television in the second room. Sharing CDs and other media content between different players in the house has similar problems.

Media servers were developed at least in part because of the problems with sharing DVDs, CDs and other media content between players in the house. Prior media servers distribute the media content to various types of set-top boxes or other devices which are connected to each of the televisions in the house. Many of these set-top boxes are designed to reformat the media content from the media server to a format that the television is able to receive and use to display the media content. Other of these set-top box devices are used for control purposes to control which television receives the media content or to transmit control signals to and from the media server so that the user can choose and play media content. Still other media servers do not offer any sort of control over the media content from the viewing location.

In all of the above instances, an additional set-top box is needed for each television that will display media content from the media server. The set-top boxes are installed between the network which carries the media content from the media server and each of the televisions. These added set-top boxes add complexity, time and expense to the set-up and use of the media server.

Some media servers are basically personal computers which are connected to the televisions in the house using an Internet Protocol (IP) wired or wireless network. In this arrangement, the media content is stored on one or more hard drives in the server and the media content is distributed to the televisions in the house using the network to play the content on any particular television. Special software is installed on the server to store and play the media content and relatively expensive dedicated IP network ports are connected to each of the televisions to receive the media content from the media server and to transfer the media content to the attached television.

Media content is typically loaded into the hard drives of the prior media server using DVD and/or CD drives. Each time that the user wishes to add media content to the media server, the user must first purchase a copy of the media content on DVD or CD or other portable storage device. Then the user has to manually install the media content from the portable storage device by placing the portable storage device in the media server and interacting with the media server software on an attached screen using a mouse and/or keyboard. This system is cumbersome and time consuming and does not offer the consumer the ability to enjoy the media content within a short time of deciding to obtain the content.

The foregoing examples of the related art and limitations related therewith are intended to be illustrative and not exclusive. Other limitations of the related art will become apparent to those of skill in the art upon reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In one example, an apparatus and method for loading media content from a remote source to a centralized media unit for selective distribution on a cable infrastructure to a plurality of media demodulation devices connected to the cable infrastructure is disclosed. The media unit connects to the remote source of media content through a single connection. A menu is generated by the media unit, the menu including information relating to the media content on the remote source. The menu is distributed from the media unit to the plurality of media demodulation devices on the cable infrastructure, and the menu is displayed on at least one of the media demodulation devices. At least some of the media content is selected for downloading from the remote source by interacting with the media unit and any given one of the plurality of media demodulation devices displaying the menu, and the selected media content is indicated to the remote source through the single connection. Selected media content is downloaded from the remote source to the centralized media unit through the single connection and a plurality of simultaneous content streams are generated, that are based at least partially on the selected media content, by the centralized media unit and the streams are distributed on the cable infrastructure to the plurality of media demodulation devices.

In another example, a media unit is disclosed for loading media content from a remote source and for selectively distributing the media content on a cable infrastructure to a plurality of media demodulation devices connected to the cable infrastructure. The media unit includes a cable infrastructure connector for connecting the media unit to the cable infrastructure and a remote source connector device for connecting the media unit to the remote source using only a single connection. The media unit also includes a menu generator for generating a menu which includes information relating to the media content available for downloading from the remote source, the media unit distributing the menu to the plurality of media demodulation devices on the cable infrastructure in a format which enables the media demodulation devices to display the menu. The media unit also including a memory device for storing local media files, a control section for receiving input from a user to select at least some of the available media content from the menu for downloading from the remote source, a communication section connected to the remote source connector device for receiving one or more commands from the control section and for communicating with the remote source through the remote source connector device to identify the selected media content and for downloading the selected media content to the memory device as local media files. The media unit further including media content stream generator connected to the cable infrastructure connector for generating a plurality of simultaneous streams of media content from local media files from the memory device based on user input and for distributing the streams on the cable infrastructure for reproduction on a plurality of the media demodulation devices.

In yet another example, a media system is disclosed for storing media content and distributing media content through a cable infrastructure in a building. The building cable infrastructure is connected to a channel service with a feed which transmits service channels from the channel service to the building cable infrastructure. The service channels include service modulated channels that are each modulated with a stream of media content from the channel service and service unmodulated channels that are not modulated with a stream of media content. The building cable infrastructure distributes the service channels through a set of legs of the building cable infrastructure to media demodulation devices positioned in the building. The media system includes a media unit which modulates the service unmodulated channels with a local content stream to create a local modulated channel. The local modulated channel is combined with the service channels on the building cable infrastructure to allow at least one of the media demodulation devices to receive the local modulated channel and to demodulate the local modulated channel to reproduce the local content stream. The media system includes a remote control with an infrared control portion for communicating with and controlling at least one of the media demodulation devices using infrared light and a radio frequency control portion for communicating with and controlling the media unit using a wireless radio frequency connection. A media file is selected from a source remote to the building for storing the selected media file on the media unit. The media unit is connected to the remote source of media files through a single connection and an interactive menu is generated as a local content stream at the media unit. At least one of the service unmodulated channels is modulated with the local content stream to create the local modulated channel on the cable infrastructure. The local modulated channel is demodulated with at least one of the media demodulation devices to reproduce the interactive menu and the remote control communicates with the media unit using the radio frequency control portion in response to user interaction with the interactive menu to select media content from the remote source and to cause the media unit to store the selected media content.

In another example, a media system is disclosed for selecting and downloading a media file from a source remote to a building which houses the media system and for storing the media file and distributing media content through a cable infrastructure in the building. The cable infrastructure is connected to a channel service with a feed which transmits service channels from the channel service to the building cable infrastructure. The service channels include service modulated channels that are each modulated with a stream of service media content from the channels service and service unmodulated channels that are not modulated with a stream of service media content. The building cable infrastructure distributes the service channels through a set of legs of the building cable infrastructure to media demodulation devices positioned in the building. The media system includes a media unit which modulates service unmodulated channels with local content streams to create a plurality of local modulated channels which can be demodulated and reproduced by the media demodulation devices. The media unit also includes a remote source connector device for connecting the media unit to the remote source of media files. The media unit includes a menu generator for generating a menu which includes a listing of media files on the remote source. The menu generator distributes the menu to the plurality of media demodulation devices on the cable infrastructure in a format which enables the media demodulation devices to display the menu. A memory device is included in the media unit for storing local media files and a control section is included for receiving a user input from a user to select the media file from the menu for downloading from the remote source. The media unit includes a communication section connected to the remote source connector device for receiving commands from the control section and for communicating with the remote source through the remote source connector device to identify the media file for downloading based on the user selection and for downloading the selected media file to the memory device through the remote source connector device. The media unit also includes a media content stream generator for generating a plurality of simultaneous local modulated channels of media content from local media files stored on the memory device. The local modulated channels are distributed on the cable infrastructure for reproduction on a plurality of the media demodulation devices. The media system also includes a combiner for connecting the media unit with the cable infrastructure to combine the local modulated channels with the service modulated channels on the building cable infrastructure to allow at least one of the media demodulation devices to receive the local modulated channels. The media system also including a remote control with an infrared control portion for communicating with and controlling at least one of the media demodulation devices using infrared light and a radio frequency control portion for communicating with and controlling the media unit using a wireless radio frequency connection to transmit the user input to the control section to identify the media file.

Another example involves a media system for storing media content and distributing media content through a cable infrastructure in a building. The building cable infrastructure is connected to a channel service with a feed which transmits service channels from the channel service to the building cable infrastructure. The service channels including service modulated channels that are each modulated with a stream of service media content from the channel service and service unmodulated channels that are not modulated with a stream of service media content. The building cable infrastructure distributes the service channels through a set of legs of the building cable infrastructure to media demodulation devices positioned in the building. The media system includes a media unit which modulates service unmodulated channels with at least one local content stream to create at least one local modulated channel. The local modulated channel is combined with the service modulated channels on the building cable infrastructure to allow at least one of the media demodulation devices to receive the local modulated channel and to demodulate the local modulated channel to reproduce the local content stream. A plurality of remote controls are included which each include an infrared control portion for communicating with and controlling at least one of the media demodulation devices using infrared light and a radio frequency control portion for communicating with and controlling the media unit using a wireless radio frequency connection. Media files that are stored on the media unit are reproduced by generating a plurality of different interactive menus at the media unit, modulating a plurality of separate service unmodulated channels with the menus to create a plurality of local modulated channels on the cable infrastructure, demodulating the local modulated channels with a plurality of the media demodulation devices to reproduce the menus on the media demodulation devices, accepting user selections with each of the remote controls, which user selections are based on one of the interactive menus reproduced on one of the media demodulation devices to select media files, communicating between each of the remote controls and the media unit with the radio frequency control portions of the remote controls to identify the media files based on the user selection, generating a plurality of local media content streams based on the identified media files, modulating the identified media file content streams to create the plurality of local modulated channels on the cable infrastructure, and demodulating the selected media file content streams with the media demodulation devices to reproduce the identified media files.

Another example involves a media system for storing media content and distributing media content through a cable infrastructure in a building. The building cable infrastructure is connected to a channel service with a feed which transmits service channels from the channel service to the building cable infrastructure. The service channels include service modulated channels that are each modulated with a stream of service media content from the channel service and service unmodulated channels that are not modulated with a stream of service media content. The building cable infrastructure distributes the service channels through a set of legs of the building cable infrastructure to media demodulation devices positioned in the building. The media system includes a media unit for modulating service unmodulated channels with local content streams to create local modulated channels. The media system also includes a combiner for combining the local modulated channels with the service modulated channels on the building cable infrastructure to allow at least one of the media demodulation devices to receive at least one of the local modulated channels and to demodulate the local modulated channel to reproduce the local content stream. The media system also includes a plurality of remote controls that each include an infrared control portion for communicating with and controlling at least one of the media demodulation devices using infrared light and a radio frequency control portion for communicating with and controlling the media unit using a wireless radio frequency communications. The media unit includes a menu generator for generating a plurality of different interactive menus and distributing the menus on the cable infrastructure as local modulated channels. The media unit also includes a control section for communicating with the plurality of remote controls using the wireless radio frequency communications and for accepting user selections from each of the remote controls, which user selections are based on one of the interactive menus reproduced on one of the media demodulation devices to identify media files for modulating as local content streams onto local channels.

Another example involves a media system which includes a media unit for generating menu and media content streams for distribution as local modulated channels to a plurality of media demodulation devices over a cable infrastructure. The media system includes a plurality of remote controls for user control over the content streams, where the remote controls transmit control code sequences to the media unit to control the content streams. The remote controls each include local channel buttons which each receive user interaction to cause the media demodulation devices to tune to a corresponding local modulated channel to display the content stream on the corresponding local modulated channel. A method for identifying which remote control controls which content stream includes transmitting the control code sequence from the selected remote control with a portion that identifies which local channel button was last pressed on the selected remote control to identify which content stream is to be controlled by the selected remote control.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a block diagram of a media system of the present disclosure, shown with remote controls and a media unit of the system connected with media demodulation devices through a cable infrastructure and to a remote source of media content.

FIG. 2 is a block diagram of a media unit of the media system shown in FIG. 1.

FIG. 3 is a block diagram of an alternate way to connect the media unit to the cable infrastructure.

FIG. 4 is another example of a connection to the remote source of media content with a media unit.

FIG. 5 is yet another example of a connection to the remote source of media content with a media unit.

FIG. 6 is still another example of a connection to the remote source of media content with a media unit.

FIG. 7 is a flow diagram of a response to a button press on one of the remote controls shown in FIG. 1.

FIG. 8 is a flow diagram of a response of by the media unit to a button press on one of the remote controls shown in FIG. 1.

FIG. 9 is a flow diagram showing control states of the remote controls shown in FIG. 1.

FIG. 10 is another flow diagram of a response to a button press on one of the remote controls shown in FIG. 1.

FIG. 11 is a flow diagram of a media unit response to a button press on one of the remote controls shown in FIG. 1.

FIGS. 12 to 24 are illustrations of menus generated by the media unit for interaction by a user to control the media unit.

FIG. 25 is a block diagram of the media unit shown in FIG. 2, illustrating additional or alternative embodiments.

### DETAILED DESCRIPTION

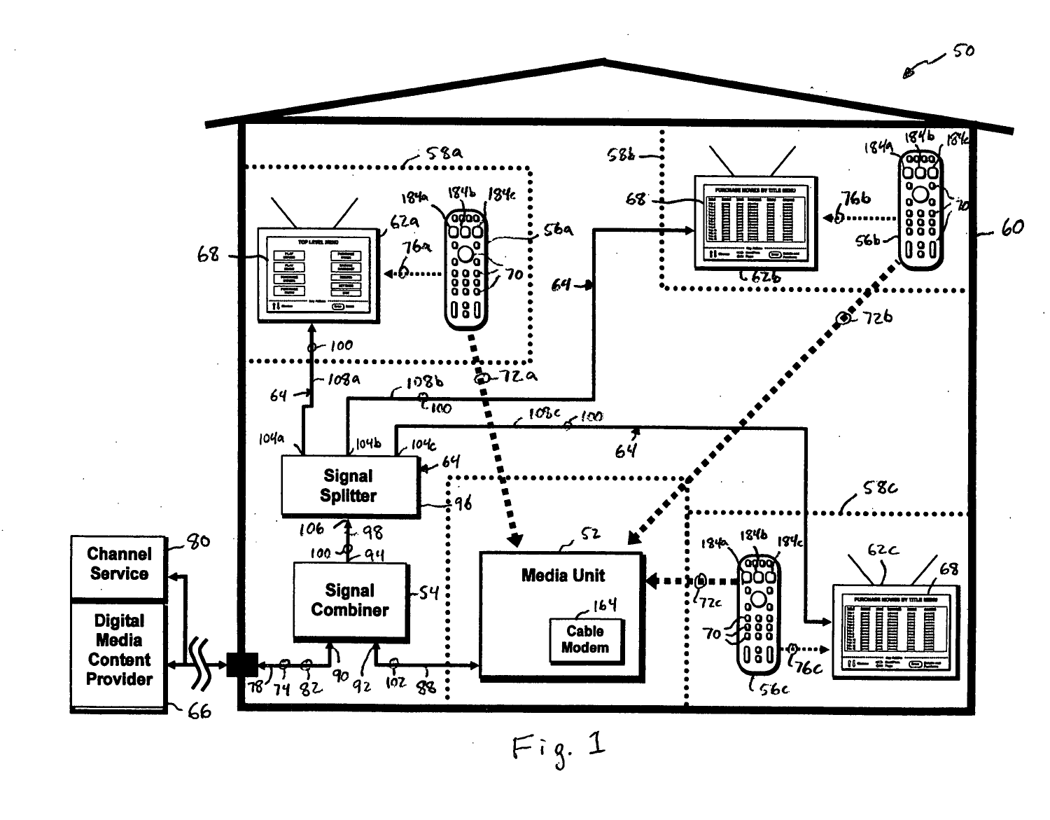

A media system 50 according to the present disclosure is shown in FIG. 1. Media system 50 includes, in this instance, a media unit 52, a signal combiner 54, which may be part of the media unit, and remote controls 56. Media system 50 allows a user to purchase, download and play media content from any room 58 in a house 60 where a television or other type of media demodulation device 62 is connected to a cable infrastructure 64 in the building. Media system 50 provides this capability without the need to add additional hardware or devices between the cable infrastructure 64 and any media demodulation devices 62 and the media system utilizes a coaxial cable infrastructure 64 that is already present in many houses.

Media content in this context can be, for example, digitally formatted video, audio and pictures, among other things and is supplied for download by one or more remote sources such as digital media content provider 66 and which may be stored as one or more media files. Using media system 50, a user can purchase and download media content such as a video or audio, save the video or audio on media unit 52 and play the video or audio on any compatible media demodulation device 62, such as a television, at any time while remaining in a single room 58 in front of a single media demodulation device. Compatibility, in this instance means that the media demodulation device can reproduce or play the media content, for instance televisions are compatible with video and audio content, while radios are typically not compatible with video content. The digital media content providers 66 may furnish lists of media content that is available for download.

Remote controls 56 are used by a user to control media system 50 to download media content by interacting with one or more menus 68 displayed on any given one or more media demodulation device 62 and with media unit 52. Remote controls 56 also contain buttons 70, some of which are menu related in that they are commonly used for manipulating menus 68. The user views menus 68 on media demodulation device 62 and presses one or more buttons 70 on remote control 56 to select media content to download from digital media content provider 66. Remote control 56 communicates the button presses to media unit 52 through a radio frequency (RF) communications link 72 and media unit 52 responds to the button presses by communicating with digital content provider 66 and downloading and saving the selected media content in media unit 52. Signals used in communicating between media unit 52 and digital content provider 66 as well as signals containing media content transferring from digital content provider 66 to media unit 52 are referred to herein as content provider signals 74.

The downloaded media content is stored in media unit 52 and the stored media content can be distributed to media demodulation devices 62 for viewing or reproduction at any time by any given one or more of media demodulation devices 62 connected to cable infrastructure 64. Control over the reproduction of the media content is accomplished using any one of remote controls 56 to interact with one or more menus 68 displayed on any one or more of media demodulation devices 62. The user selects media content for reproduction from menu 68 by pressing one or more buttons 70 on remote control 56 which are media playback related buttons, and in response, remote control 56 transmits information about which buttons 70 were pressed to media unit 52 using RF link 72. Media unit 52 plays the selected media content on one or more of media demodulation devices 62 through cable infrastructure 64. While the media unit 52 plays the selected media content, the media playback related buttons are used for controlling the playing without having to display a menu.

In the example shown in FIG. 1, all of remote controls 56a, 56b and 56c are substantially the same and each of remote controls 56a, 56b and 56c is located in a corresponding room 58a, 58b and 58c with one corresponding media demodulation device 62a, 62b and 62c, respectively. Some of buttons 70 on remotes 56 are used for controlling functions of media demodulation devices 62 using infrared (IR) links 76. Remote controls 56 include operational capabilities to control media demodulation devices 62 in a manner similar to universal remote controls which are programmed to send control codes corresponding to a particular brand and model of a media demodulation device 62. Remote controls 56 can also include universal remote functionality to control other devices, such as DVD and other players. The IR and RF links are communication links using known methods for communicating between two devices.

A channel feed 78 such as an antenna or cable service feed is connected to cable infrastructure 64 to connect a channel service 80 which supplies specific frequency bands corresponding to FCC allocated channels for broadcast or cable television to media demodulation devices 62. Each of media demodulation devices 62 are able to selectively tune and demodulate the frequency band corresponding to a FCC allocated channel and reproduce the audio and/or video content contained within the channel. Signals from the cable or other type of channel service are referred to herein as service channels 82. Typically channel service 80 will only use a portion of the allocated channels while leaving the other channels unused, therefore service channels 82 include service modulated channels which are used by channel service 80 and service unmodulated channels which are not used by channel service 80. The service modulated channels are modulated with service media content, such as audio and visual media from television stations.

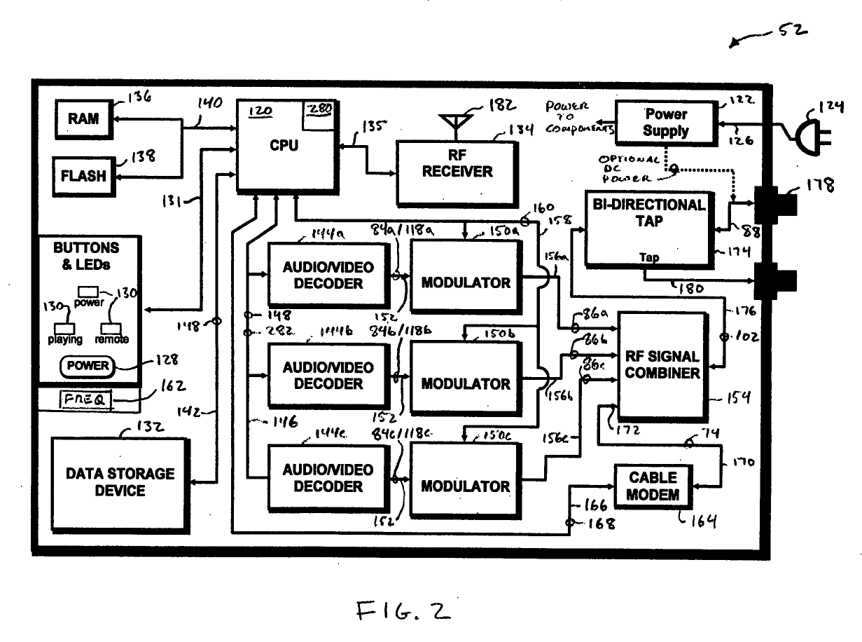

Media unit 52 stores the downloaded media content as one or more local media files. Media unit 52 creates local media content streams 84 (FIG. 2) from the local media files when the user wishes to view the media content on media demodulation devices 62. Media unit 52 then modulates content streams 84 to produce local modulated channels 86. Local modulated channels 86 are signals within a frequency band corresponding to a FCC allocated channel and which is modulated according to a standard which allows local modulated channels 86 to be received and demodulated and displayed by media demodulation devices 62. Media unit 52 can simultaneously create multiple different local modulated channels 86 from multiple different media files. In the present example, each of multiple local modulated channels 86 is created by media unit 52 with a signal within a frequency band of a different one of the service unmodulated channels. This allows local modulated channels 86 to be carried on cable infrastructure 64 without interfering with the service modulated channels. Local modulated channels 86 are carried from media unit 52 to cable infrastructure 64 with a media unit feed 88.

Signal combiner 54, shown in FIG. 1, includes an input port 90 connected to channel feed 78, an input port 92 connected to media unit feed 88 and output port 94 connecting signal combiner 54 to a signal splitter 96 of cable infrastructure 64 using a cable infrastructure feed 98. Signal combiner 54 additively combines service channels 82 and local modulated channels 86 into a combined channel signal 100 that is sent to cable infrastructure 64 over cable infrastructure feed 98.

In the example shown in FIG. 1 and 2, channel service 80 provides service channels 82 and also serves as digital content provider 66. Media feed 88 carries digital content provider signals 74 to and from digital media content provider 66 as well as carrying local modulated channels 86 from media unit 52 to signal combiner 54. Media unit feed 88 may have parts interior and exterior to media unit 52, as shown in FIGS. 1 and 2. The combination of local modulated channels 86 and content provider signals 74 are referred to as combined media unit signals 102. Channel feed 78 also carries digital content provider signals 74 as well as carrying service channels 82. Signal combiner 54, shown in FIG. 1, includes the capability of bi-directional transfer between input ports 90 and 92. This capability allows content provider signals 74 to transfer through signal combiner 54 between channel feed 78 and media unit feed 88 which allows communication between media unit 52 and digital content provider 66 for purchasing and downloading media content.

Cable infrastructure 64, shown in FIG. 1, is typical of cable infrastructures installed in houses for distributing cable or broadcast television signals to various media demodulation devices 62 in the house. Cable infrastructure 64 carries combined channel signal 100 to media demodulation devices 62, and in the present example, any of media demodulation devices 62 can demodulate and reproduce the media content on any of the modulated channels.

Cable infrastructure 64 in the example shown in FIG. 1, includes signal splitter 96 having three output ports 104 and a single input port 106. The cables connected to cable infrastructure 64 and used in cable infrastructure 64 in the present example are coaxial type cables, although other types of cables may also be used. Input port 106 is connected to cable infrastructure feed 98 to receive combined channel signal 100 from signal combiner 54. Signal splitter 96 sends combined channel signal 100 from input port 106 to all of output ports 104. Output ports 104 are connected to cable legs 108 which each extend from an output port 104 of signal splitter 96 to a media demodulation device 62 in different rooms 58 in the house. Cable legs 108 distribute combined channel signal 100 from splitter 96 to media demodulation devices 62 in different rooms 58.

Cable infrastructure 64 may include more or less input and output ports and legs than what are shown in FIG. 1, or may be configured differently to include more or less components as long as cable infrastructure 64 distribute the combined channel signal to media demodulation devices 62. Typical cable infrastructures may include various components such as: connectors, couplers, wall plates, multiple segments of cable, and/or other components.

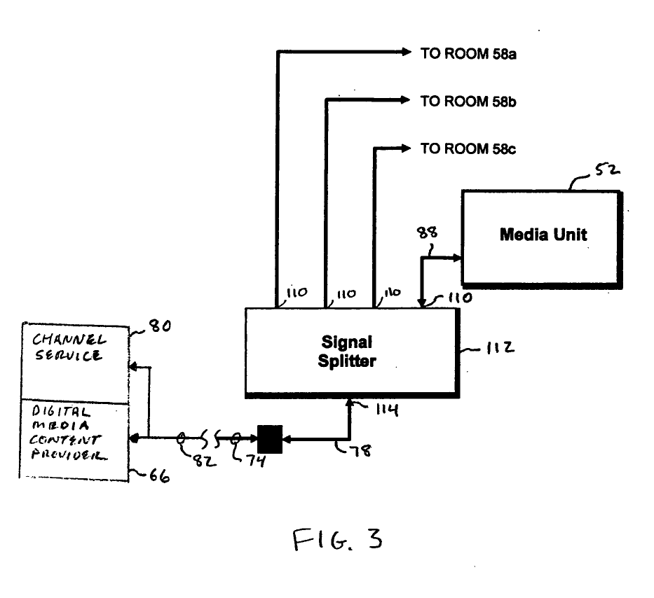

As an alternative to connecting media unit 52 to cable infrastructure 64 with a signal combiner 54, media system 50 can connect directly to a signal splitter in some instances, as shown in FIG. 3. In these instances media system 50 will not include a signal combiner 54, instead having media unit 52 connected to an output port 110 of a signal splitter 112. Signal splitter 112 in this instance has certain characteristics which allow signals to pass between an input port 114 and output ports 110 bi-directionally and also must allow signals to pass between one output port 110 and all other output ports 110. Signal splitter 112 allows content provider signals 74 to pass bi-directionally between input port 114 and output ports 110 so that media unit 52 can communicate with digital media content provider 66. Signal losses through various paths in the splitter may have to be compensated for by making appropriate adjustments in the input and output sensitivities and levels. A signal splitter having these capabilities may require DC power. In these instances, DC power can be provided to signal splitter 112 over media unit feed 88 from media unit 52.

Media demodulation devices 62 used with media system 50 are standard media demodulation devices 62 in that they are not modified to interact with media system 50. Media demodulation devices 62 can be audio and visual equipment such as televisions, audio only devices, such as stereos, video only devices for displaying pictures or other devices which are capable of demodulated modulated channels. Media demodulation devices 62 are connected to cable infrastructure 64 in the same manner when media system 50 is used as they are when media system 50 is not used so no special connection is required. Media demodulation devices 62 are selectively tunable to any of service channels 82 or local modulated channels 86 on cable infrastructure 64 and are controllable for channel selection and other functions using infrared communications with one of remote controls 56 over IR link 76.

Media demodulation devices 62 can be tuned to the same or different channels at the same or different times. In this way, by tuning more than one media demodulation device 62 to the same local modulated channel 86, the same media content from media unit 52 can be reproduced simultaneously on more than one media demodulation device 62. By tuning media demodulation devices 62 to different local modulated channels 86a, 86b or 86c, different media content from media unit 52 can be reproduced on different media demodulation devices 62a, 62b or 62c simultaneously. The service modulated channels are essentially unaffected by the use of cable infrastructure 64 by media system 50.

Menus 68 are generated by media unit 52 and sent to media demodulation devices 62 using cable infrastructure 64. Media unit 52 generates local menu content streams 118 of audio and/or video which contain menu information generated by media unit 52. Media unit 52 modulates menu content streams 118 to produce local modulated channels 86. Interaction with media unit 52 to manipulate menus 68 is accomplished via radio frequency communications between remotes 56 and media unit 52 over RF links 72. Media unit 52 responds to user interaction with remote control 56 by indicating the user interaction in menu 68 displayed by media demodulation device 62. In this way the user can interface with menu 68 to order, purchase, download and play media content using remote controls 56.

Local modulated channels 86 are used for alternatively transmitting menu content and media content to media demodulation devices 62. This allows a user to interact with a menu 68 viewed on a media demodulation device 62 to purchase and download media content as well as play the media content on any of media demodulation devices 62.

Details of media system 50 which accomplishes the functions discussed above will now be discussed. A diagram of an exemplary media unit 52 is shown in FIG. 2. Media unit 52 shown is an embedded system with a central processing unit (CPU 120) which is connected to various peripheral subsystems. While the block diagram shows seperate connections between CPU 120 and each of the peripherals, it should be noted that such connection is illustrative. CPU 120 can be connected to the peripherals using a common peripheral I/O bus with different chip select signals and/or different address decoding logic allowing CPU 120 to manage their communication on the bus such that the communication occurs only with a single/selected peripheral at any given time. Other communication connections and techniques for communicating between peripherals and CPU 120 and between peripherals may also be used as are commonly found in embedded systems.

Media unit 52 includes a power supply 122 which provides the appropriate power to all circuits in media unit 52. Power supply 122 connects to a receptacle (not shown) using a plug 124 connected to a cable 126. In the embodiment shown, power supply 122 connects with a 120 V alternating current (AC) outlet typically found in house 60 or other building. Power supply 122 converts the AC energy into DC energy and distributes the DC energy on power lines (not shown) for use by the components of media unit 52.

Media unit 52 may include various buttons, such as power button 128, for controlling media unit 52 and/or powering up media unit 52. Media unit 52 can also include various LEDs 130 which indicate whether media unit 52 is powered up, or if other parts of media unit 52 are functioning, such as whether media unit 52 is playing media content or if media unit 52 is communicating with one or more of remote controls. LEDs 130 and/or buttons are connected to CPU 120 with one or more LED/button lines 131. It should be understood that FIG. 2 is diagrammatic and different connections may be used.

CPU 120 may consist of a single microprocessor IC or may be multiple ICs which may or may not include multiple microprocessor ICs and/or other ICs which implement various peripheral functions. CPU 120 runs software which monitors for various input conditions and responds appropriately. For instance, CPU 120 manages data flow between a memory device such as data storage device 132 and other peripherals. CPU 120 coordinates the operation and control of various other peripherals in the embedded system, as well as providing other typical functions of a CPU in an embedded system.

CPU 120 also accepts input from remote controls 56 and coordinates communication through a control section such as RF receiver 134 of media unit 52 over a receiver line 135. In the example shown in FIG. 2, CPU 120 is used in creating menus 68 and manages the user interaction with the menus by communicating with remote controls 56 through RF receiver 134. In this way the CPU acts as a communication section of media unit 52. CPU 120 also manages connectivity to digital content provider 66 for purchasing and downloading media content among other things.

Media unit 52 includes memory such as RAM 136 for storing data and various software for running on CPU 120. Flash memory 138 is also included in media unit 52 shown in FIG. 2. The RAM and Flash memory are connected to CPU 120 using a memory bus 140. Flash memory 138 stores an operating system, applications, drivers and other programs which run on CPU 120 and perform control/coordination functions with the various peripherals. Flash memory 138 may also contain a small amount of “bootloader” software which functions to read in the full set of system software from data storage device 132 similar to the way in which a PC boots up and loads its operating system from a hard disk drive.

Data storage device 132 is a non-volatile digital memory device with high storage capacity for storing the local media files and/or other content. Data storage device 132 is connected to CPU 120 using a data storage bus 142 which transfers control and/or data signals between data storage device 132 and CPU 120. Data storage device 132 stores the digital media content, such as movies, songs, photos and other content as well as other data/files related to the operating system and/or other software. Data storage device 132 is connected to CPU 120 using an interface such as ATA, Serial-ATA, SCSI, CE-ATA or others. Storage device 132 can be a hard disk drive or multiple hard disk drives to achieve a higher capacity. In addition or alternatively, data storage device 132 could include a redundant array of inexpensive devices (RAID) type storage to protect against data loss if one of the hard disk drives fails. Other types of nonvolatile digital storage devices could be used, such as large amounts of flash memory, tape, optical, holographic storage devices, or other types of storage devices having large capacities. Data storage device 132 can be internal or external to the media unit and may also be readily expandable or upgradeable. External data storage devices may be connected by network attached storage or as a modular device to the media unit as an external USB drive.

Media unit 52 includes multiple audio/video decoders 144 for taking digitally encoded media content and decoding the content into the analog audio and video content streams 84. Decoders 144 are connected to CPU 120 with a decoder bus 146 to receive digitally encoded media content streams 148 from data storage device 132 through CPU 120, which together act as one example of a media content stream generator. Following decoding by decoders 144, decoded content streams 84 are sent through decoded signal lines 152 to a modulation section having modulators 150. Digitally encoded media content which is stored in data storage device 132 are transferred to decoders 144 as encoded content streams 148 over data storage bus 142 and/or other data lines under the control of CPU 120. Control bus 158 carries control signals 160 between modulator 150 and CPU 120. Each of audio/visual decoders 144 include all of the necessary primary and secondary integrated circuits and passive components required to perform a complete audio/video decoder function. In one instance this includes, a dedicated audio/video decoder IC such as Sigma Designs EM8510 IC or the Phillips Nexperia PNX17xx series IC as well as an additional memory for the decoding function and for other software which runs on the audio/video decoder IC.

As an alternative, or in addition to generating menus 68 with CPU 120, each of audio/video decoders 144 can also contain the necessary circuits and algorithms to generate and output menu content streams 118 to modulators 150 through decoded signal lines 152. One exemplary decoder utilizes a Sigma Designs EM 8510 IC which contains an internal capability to generate an on-screen display (OSD). The OSD function can be used for generating the menu and for placing the menu onto the decoded signal lines as menu content stream 118. In this case, the software running on CPU 120 and software running on the decoders act cooperatively. The CPU communicates instructions to the decoder about what menu should be generated and may also provide lists of content to display on the menu. The decoder software then generates the appropriate menu using the instructions and content from the CPU.

There are three decoders 144 shown in the example in FIG. 2. More or less decoders can be included in media unit 52 depending on the number of desired simultaneous local modulated channels 86. In addition, it is possible to combine multiple audio/video decoders 144 into a single device. For instance, one integrated circuit device could contain multiple independent copies of audio/video decoders 144 or one integrated circuit device may contain a single processor and associated circuitry capable of decoding multiple encoded content streams simultaneously. In other instances, certain CPUs may be powerful enough to run decoding software for multiple simultaneous content streams. In these instances the CPU would receive media content streams 148 from data storage device 132, decode digitally encoded media content streams 148 and send the decoded data to D/A converters (not shown) which would produce analog audio and video content streams 84 before sending them to modulators 150.

Modulators 150 receive decoded content streams 84 from decoders 144 and convert them into RF signals at a frequency corresponding to a channel under the control of CPU 120. In this way, local modulated channels 86 are generated from analog audio and video content streams 84. Local modulated channels 86 generated by modulators 150 shown in FIG. 2 are capable of demodulation by any of media demodulation devices 62 which allows media demodulation devices 62 to reproduce audio and video content streams 84. Local modulated channels 86 are sent from modulators 150 to an RF signal combiner 154 through modulator output lines 156.

Each modulator 150, shown in FIG. 2, converts one of content streams 84 from decoders 144 into local modulated channels 86 capable of demodulation by media demodulation devices 62. Digital type modulators 150 can be easily adjusted to modulate content streams 84 from decoders 144 onto different channels/frequencies under control of CPU 120 over modulator control bus 158. These modulators 150 can modulate onto either the standard set of broadcast frequencies, or onto the standard set of cable frequencies, depending on which of these frequencies exist in service channels 82. In the present example, a user selects the frequency set that modulators 150 modulate onto using a frequency set switch 162 which is connected to CPU 120. One example of the type of adjustable digital modulators 150 is a Freescale MC44BS374CA device. The number of decoders 144 and modulators 150 shown in FIG. 2 corresponds to the number of local modulated channels 86 produced by media unit 52. More or less decoders 144 and modulators 150 can be included depending upon the number of local modulated channels desired 86. The number of inputs on RF signal combiner 154 is adjusted according to the number of modulators 150.

A cable modem 164 is included in media unit 52 for providing bi-directional communications with digital content provider 66 to access, select, purchase and download media content from digital content provider 66 through a single connection. Cable modem 164 is connected to CPU 120 with a modem control line 166 for control signals 168 and/or other data flow between CPU 120 and cable modem 164. Cable modem is connected to RF signal combiner 154 with a cable modem line 170 for transferring content provider signals 74 to and from cable modem 164.

The bi-directional communication between cable modem 164 and digital content provider 66 is accomplished in a manner similar to what occurs in cable modem device/technology providing internet service to a personal computer in the house. While modem 164 is shown internal to media unit 52, modem 164 can also be positioned as a separate unit so long as the modem provides communication between media unit 52 and digital content provider 66.

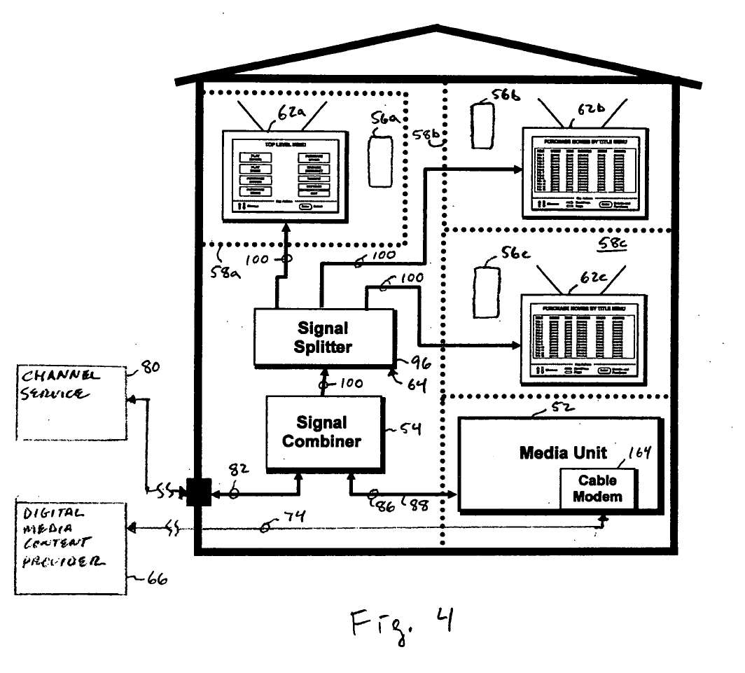

RF signal combiner 154 of media unit 52 combines the separate local modulated channels 86 from modulators 150 and digital content provider signal 74 traveling from cable modem 164 to digital content provider 66 into combined media unit signal 102. Cable modem 164 is connected to a bi-directional port 172 of RF signal combiner 154 that provides bi-directional communications between digital content provider 66 and cable modem 164. In other instances of the single connection to digital content provider 66, cable modem 164 or other remote source connector device is connected to the remote digital content provider 66 without sharing a cable or connection with local modulated channels 86, such as is shown in FIG. 4 for example. Other remote source connector devices which may be used in certain circumstances include DSL modems, Ethernet Adaptors, USB adaptor, wireless wide area network adaptors, satellite dish, and others.

RF signal combiner 154, shown in FIG. 2, is connected to an optional bi-directional tap 174 using a RF signal combiner output line 176. If the bi-directional tap is not included, then RF signal combiner output line 176 serves as media unit feed 88. Media unit 52 may include a connector 178 to facilitate connection between media unit 52 and the cable infrastructure 64, and/or to the signal combiner 54 when signal combiner 54 is external to media unit 52.

Optional bi-directional tap 174 can be included in media unit 52 for connecting local modulated channels 86 and digital content provider signal 74 to an optional media demodulation device (not shown) located in the same room as media unit 52 without using cable infrastructure 64 to carry these signals. In this instance the optional media demodulation device is connected to a tap line 180 coming from bidirectional tap 174. Bi-directional tap 174 allows signals to pass through in both directions between media unit connector 178 and RF signal combiner 154. Tap line 178 carries local modulated channels 86 and digital content provider signal 74 in an attenuated form. The attenuation level is set for a level suitable to connect to the media demodulation device located in the same room as media unit 52.

In instances where DC power is needed for a signal splitter 112 or signal combiner 54 as described above in conjunction with FIG. 3, power supply 122 can supply the DC power to signal splitter 112 or signal combiner 54 through media unit feed 88. In these instances bidirectional tap 174 will include a DC blocking capability to prevent the DC power from reaching RF signal combiner 154. DC power can be provided to signal combiner 54 for powering active circuits in the signal combiner, such as filters.

RF receiver 134 of media unit 52 is connected to CPU 120 with receiver line 135 to allow media unit 52 to communicate with remote controls 56 via the RF communication links. RF receiver 134 receives RF signals of the RF link on an antenna 182 modulated with control code sequences, which have been transmitted from one or more of remote controls 56. RF receiver 134 demodulates the RF signals and then passes the control code sequences to CPU 120 on receiver line 135. CPU 120 responds to the control code sequences in a manner depending on which buttons 70 on remote control 56 were pressed.

Remote controls 56 of media system 50 are each essentially identical and each of the remotes is typically used with one of media demodulation devices 62. Remote controls 56 are generally located in the same rooms 58 as media demodulation devices 62 with which it is used. In the example shown in FIG. 1 there are three remote controls 56a, 56b and 56c, one for each room 58a, 58b and 58c which each have a media demodulation device 62a, 62b and 62c, respectively. More or less remotes could be used with media system 50 depending on the number of remotes desired by the user. In most instances the user may desire to have a remote control 56 for every media demodulation device 62 in the house. In other instances the user may not have a remote control 56 for every media demodulation device 62 in the house. Media system 50 may be purchased with a certain number of remote controls, and additional remote controls 56 may be purchased separately.

Each of remotes 56 contain an assortment of buttons 70, some of these buttons are for controlling a media demodulation device 62 such as media demodulation devices 62 shown in FIG. 1. Examples of these buttons includes: power on and off, channels selection, volume, mute, numeric buttons and others. In addition, some buttons 70 are used for manipulating menus related to settings in media demodulation device 62. Examples of these types of buttons include navigation buttons such as up, down, left, right, as well as menu, enter and cancel or back buttons.

The assortment of buttons 70 also includes media playback buttons for controlling media playback from media unit 52. The media playback buttons may include, play, pause, stop, fast forward, fast reverse, skip to next and skip to previous, and/or others. In addition, buttons 70 of remotes 56 may include a program button for programming the remote control.

Each remote 56 also includes local channel buttons 184a, 184b and 184c, which are used for the activation and control of local modulated channels 86a, 86b and 86c, respectively. In the example shown in FIGS. 1 and 2, remotes 56a, 56b and 56c each include three local channel buttons, one local channel button 184a, 184b and 184c for each of local modulated channels 86a, 86b and 86c. This allows each remote 56 to control content streams 84a, 84b and 84c and menu content streams 118a, 118b and 118c independently. In the present example, there are three local channel buttons 184, other numbers of local channels can be provided. Buttons 70 described are exemplary; more or less buttons may be needed to implement remote control 56 for media system 50. In addition, other buttons and modes of operation, not described, may be needed in some instances while some buttons described above may not be required in all instances.

Remote controls 56 of media system 50 include infrared (IR) communication capabilities for communicating with media demodulation devices 62 through the IR link and RF communication capabilities for communicating with media unit 52 through the RF link. Remote control 56 of the present example includes a microprocessor to generate various control code sequences via software algorithms and other necessary circuitry and devices to convert the control code sequences into IR or RF signals. In addition, remotes 56 includes non-volatile memory (not shown) in order to retain information programmed into the remote.

IR link 76 between remote control 56 and media demodulation device 62 is created by remote 56. IR is used for communicating with media demodulation devices 62 since most media demodulation devices 62 already incorporate a system for receiving control using IR. Each remote 56 is pre-programmed with control codes for common brands of media demodulation devices 62. A user can program remotes 56 to utilize the set of IR control codes corresponding to the particular media demodulation device 62 located in the same room 58 with remote 56 by following simple instructions. Remote 56 stores the programmed information in the non-volatile memory. Programming remotes 56 for IR communication with a particular media demodulation device 62 is done in a manner similar to methods used for programming universal remote controls.

The RF communication capability of remotes 56 is used for communicating controls from remote control 56 to media unit 52 through wireless RF link 72. Remote 56 transmits sequences of ones and zeros (a sequence of bits) over RF link 72 to media unit 52. Pressing different ones of buttons 70 and different ones of local channel buttons 184 on remote control 56 produce different sequences of bits, or control codes, to be transmitted to media unit 52 over the RF link. One or more control codes that are transmitted sequentially, either through IR link 76 or RF link 72, are control code sequences.

The number of bits in a particular control code can be generally chosen according to the requirements of the system design. Components and devices that transmit and receive the control code sequences over RF link 72 can be generally programmed to accommodate the number of bits required. Furthermore, the ordering and meaning of the bits can be chosen according to the requirements of the system design. Well known methods exist to create, receive, decode and interpret particular sequences of bits in a control code.

Each press of a button 70 or 184 produces a response in the remote control: either a control code sequence is transmitted by IR link 76 to media demodulation device 62, or a control code sequence is transmitted by RF link 72 to media unit 52, or two different control code sequences are transmitted, one through IR link 76 to media demodulation device 62 and one through RF link 72 to media unit 52. Generally, button presses associated with the typical buttons used for controlling a media demodulation device 62 will cause the appropriate control code sequence to be transmitted by IR link 76; and generally presses associated with menu related buttons will cause a control code sequence to be transmitted to either media demodulation device 62 by IR link 76 or to media unit 52 by RF link 72. Button presses associated with media playback buttons will cause control code sequences to be transmitted to media unit 52 over RF link 72. Button presses associated with local channel buttons 184 cause control code sequences to be transmitted to media demodulation devices 62 by IR link 76 and to media unit 52 by RF link 72.

Although menu related buttons are described as causing control code sequences to be transmitted to media unit 52 through RF link 72, in some instances menu related buttons may cause control code sequences to be transmitted to media demodulation devices 62 through IR link 76. One such instance is where the user desires to access and manipulate menus generated and displayed by media demodulation devices such a initial setup menus for the media demodulation device 62. In this instance remote control 56 would send control codes through IR link 76 to media demodulation device 62 in response to menu button presses on remote control 56. Also, an existing or additional button could be used in this instance to cause remote control 56 to produce IR control code sequences in addition to or instead of RF related control code sequences for menu related button presses.

Since media unit 52 utilizes channel space made available by service unmodulated channels for local modulated channels 86, these unmodulated channels are programmed into media unit 52 and remote controls 56. In the present example, a user identifies the service unmodulated channels by tuning one of media demodulation devices 62 through at least a portion of service channels 82, including the service modulated channels and service unmodulated channels. The user identifies the service unmodulated channels as service channels 82 which do not contain content from channel service 80. The user may also identify adjacent service unmodulated channels that are grouped together in series. There may be benefits to using one or more channels in grouped service unmodulated channels for local modulated channels since these channels may have less interference from adjacent channels.

In some instances, the service unmodulated channels are fixed to such a degree that the media unit can be hard-coded to use these service unmodulated channels as the local modulated channels. One instance of this is where the media unit is manufactured or provided by the channel service provider. In this instance, the channel service provider can designate certain channels to function as the local modulated channels and leave these certain channels as service unmodulated channels.

The number of identified service unmodulated channels should equal or exceed the number of local modulated channels 86 produced by media unit 52 since each of local modulated channels 86 will use a separate service umodulated channel. If there are not enough service unmodulated channels for all of the local modulated channels capable in media unit 52, then the user may choose to not use all of the local modulated channels.

Media system 50 may include the capability to use one or more of the service modulated channels as local modulated channels. In this instance, media system 50 may include one or more filters, such as channel specific or channel range notch filters, for filtering out the service modulated channel before using the channel as a local modulated channel. In these instances, the filtered channel is also considered as a service unmodulated channel. Such filters may be positioned between the channel feed 78 and signal combiner 54. The user may select a service modulated channel which carries content that is not of interest to the user to user as a local modulated channel.

Once the user has identified a sufficient number of service unmodulated channels, the user can then proceed to program media unit 52 to utilize the identified service unmodulated channels using any given one of remote controls 56. Media unit 52 is programmed to use the identified service unmodulated channels as local modulated channels 86 through specific sequence of button presses on a selected remote 56. An exemplary programming sequence involves: first pressing the program button; then pressing one of local channel buttons 184; then entering one of the service unmodulated channel numbers using numeric buttons of buttons 70; and finally pressing the program button again.

The exemplary sequence causes the selected remote to transmit to media unit 52 which local channel button 184 has been pressed and which service unmodulated channel number has been entered. Media unit 52 responds by storing the service unmodulated channel number in the non-volatile memory, such as data storage device 132. The exemplary programming sequence is repeated using a different service unmodulated channel number for each of local channel buttons 184a, 184b and 184c on the selected remote 56. In this way, media unit 52 is programmed with the channels available for use as local modulated channels 86a, 86b and 86c so that CPU 120 can control modulators 150 to modulate content streams 84 and 118 to the unused service unmodulated channel frequencies as local modulated channels 86. Subsequent to executing the programming sequence, each of local channel buttons 184a, 184b and 184c on the selected remote 56 has an associated local modulated channel 86a, 86b and 86c, respectively in this instance. Media unit 52 can be reprogrammed for a different service unmodulated channel using any remote controls 56 if one or more of a service unmodulated channels begins to be used by channel service 80.

In addition to programming media unit 52 to use the service unmodulated channels for local modulated channels 86, the exemplary programming sequence also causes the selected remote control 56 to store the service unmodulated channels into nonvolatile memory in selected remote control 56. In this way, each local channel button 184 is associated with one of local modulated channels 86. After following the programming sequence, pressing one of local channel buttons 184a, 184b or 184c causes remote control 56 to send an IR signal to media demodulation device 62 which responds to this signal by tuning to local modulated channel 86a, 86b or 86c associated with the local channel button that was pressed. Pressing local channel button 184 also causes media unit 52 to respond by creating local modulated channel 86 associated with local channel button 184 that was pressed, typically initially as a menu 68.

The non-selected remote controls 56, which were not used to initially program media unit 52, are programmed to store the service unmodulated channels into non-volatile memory without reprogramming media unit 52. In the present example, this is accomplished by: pressing the program button; pressing one of local channel buttons 184; entering the service unmodulated channel that is associated with the local channel button pressed; and then pressing the enter button. This sequence is repeated for each of local channel buttons 184 on each of the non-selected remote controls 56. Once this process is complete all of remote controls 56 will be identically programmed with service unmodulated channel numbers corresponding to each of local channel buttons 184, and media unit 52 will be programmed with the same information. Consequently, each of remote controls 56 will be able to coordinate actions between media unit 52 and their corresponding media demodulation device 62 in such a way that the user need not remember which service unmodulated channel is associated with each of local modulated channels 184.

As discussed, the exemplary media system 50 shown in FIG. 1 utilizes channel feed 78 to connect media unit 52 to digital content provider 66. In this example, channel service 80 and digital content provider 66 share channel feed 78. In this instance, media unit 52 communicates bi-directionally with digital content provider 66 through a single physical connection to media unit 52.

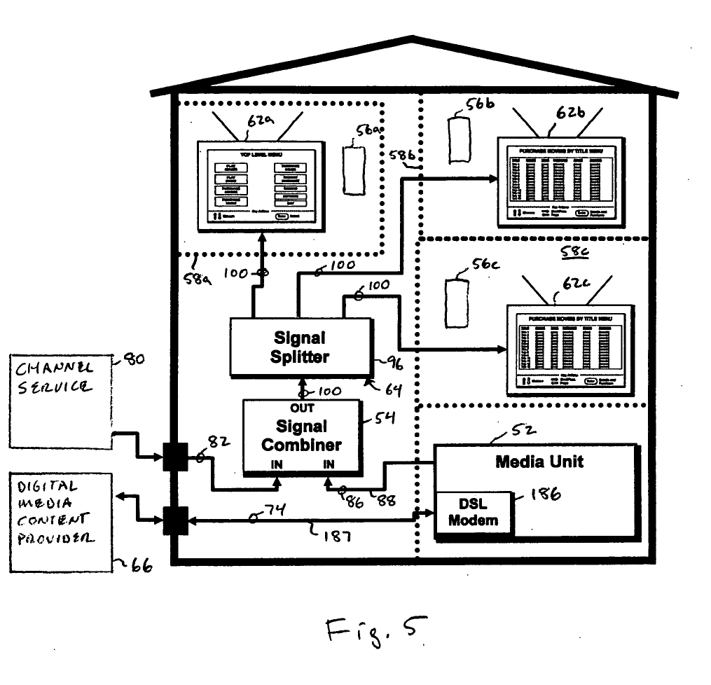

Other embodiments can also be used for connecting media unit 52 to digital content provider 66. In some instances, channel service 80 and the digital media content provider may not share a line such as channel service feed 78. In these instances cable modem line 170 of media unit 52 is not connected to RF signal combiner 154 as shown in FIG. 2, but instead connects to digital media content provider 66 as shown in FIG. 4. In another instance, the single connection for purchasing and downloading media content is accomplished through a phone line such as a DSL connection, as shown in FIG. 5. In this instance cable modem 164 may be replaced with a DSL modem 186 which is connected to a phone line 187 which would carry content provider signals 74 between digital media content provider 66 and media unit 52, as shown in FIG. 5.

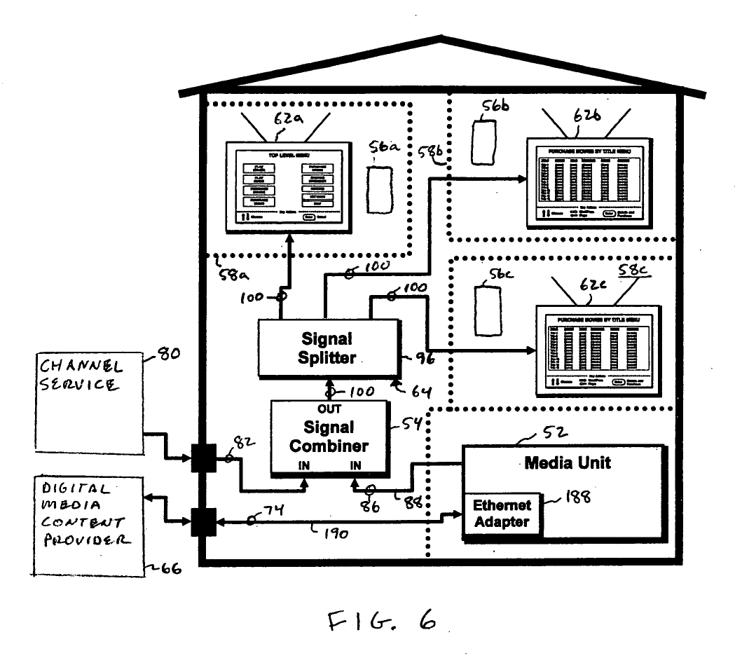

In another instance, shown in FIG. 6, media unit 52 includes a single connection through an ethernet adaptor 188 that is connected to digital content provider 66 through a local area network 190. Local area network 190 is connected to the Internet to provide data connection to digital content provider 66. In this instance cable modem 164 is replaced by ethernet adapter 188 and an ethernet based connection. In some instances the single connection is a dedicated internet connection. Both the DSL and the Ethernet connections to digital content provider 66 allow bidirectional communication between media unit 52 and digital content provider 66 which reduces complexity in the installation and setup, as well as reducing cost because only a single line must be maintained, among other reasons. Other bi-directional communication connections and protocols can also be used between media unit 52 and digital content provider 66, such as through a satellite dish, as well as multiple single direction communication connections.

The operation of media system 50 is simple and transparent to the user. Media system 50 coordinates the operation of remote controls 56, media unit 52 and media demodulation devices 62. Remote controls 56 control media unit 52 through RF links 72 and media demodulation devices 62 through IR links 76, as appropriate, in response to pressed buttons 70 and/or 184 by a user.

After media system 50 has been connected to cable infrastructure 64 and remote controls 56 and media unit 52 have been programmed with the service unmodulated channels and media unit 52 has been powered up, media system 50 is essentially ready to use to select and download media content, or to play media content already stored in media unit 52.

Each local modulated channel 86 is “active” when media unit 52 is generating either menu 68 or decoding digital content on the local modulated channel. Each local modulated channel 86 is “inactive” when media unit 52 is not generating either menu 68 or decoding digital content on the local modulated channel.

When first powered up, media unit 52, after performing initializations typical of a media server device, enters a state where it is waiting to receive control code sequences from any of the remote controls and where all the local channels are inactive. Typically, when inactive, some of the peripheral devices in media unit 52 such as audio/video decoders and modulators are placed in a low-power state. Subsequently, when local channels become active, such as by the user pressing one or more local channel buttons, the aforementioned peripheral devices are placed in a normal operational state.

Pressing one of local channel buttons 184 on any given one of remote controls 56 causes media demodulation device 62 and media unit 52 to respond in different ways depending on whether local modulated channel 86 associated with local channel button 184 was active or inactive when the local channel button was pressed.

The net result of pressing local channel button 184 is that media demodulation device 62 and media unit 52 are coordinated to make use of a service unmodulated channel as a local modulated channel 86 and output from media unit 52 is displayed on media demodulation device 62. The particular output displayed will depend upon whether or not the corresponding local modulated channel 86 is already active at the time local channel button 184 is pressed. If local modulated channel 86 was inactive then an Initial Menu 192 is generated and modulated in media unit 52 and is displayed on media demodulation device 62. If local modulated channel 86 was active, then menu 68 or content stream already being generated and modulated by media unit 52 will be displayed on media demodulation device 62.

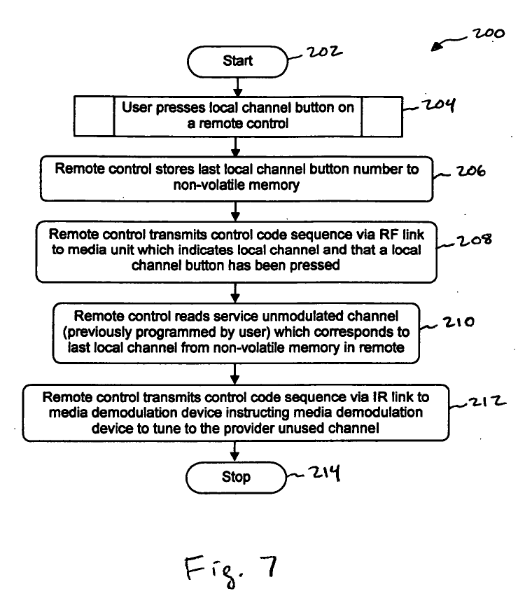

One example of the response of remote control 56 to pressing one of local channel buttons 184 on one of remote controls 56 is shown by a method 200 illustrated by the flow diagram in FIG. 7. Method 200 begins at a start 202 from which the method proceeds to step 204. At step 204 a selected one of remote controls 56 receives a button press from a user on a selected one of local channel buttons 184. Method 200 proceeds to step 206 where remote control 56 stores data relating to which local channel button 184 was pressed in memory. The method then proceeds to step 208 where remote control 56 transmits a control code sequence to media unit 52 over RF link 72. The control code sequence transmitted in step 208 indicates to media unit 52 that one of local channel buttons 184 was pressed. The control code sequence also indicates to media unit 52 which of local channel buttons 184 was pressed.

The method then proceeds to step 210 where remote control 56 determines from memory the channel number of local modulated channel 86 corresponding to the pressed local channel button 184. The channel number of local modulated channel 86 corresponding to the pressed local channel button 184 is the number of the service unmodulated channel previously programmed by the user for the pressed local channel button 184. The method then proceeds to step 212 where remote control 56 transmits a control code sequence through IR link 76 instructing media demodulation device 62 to tune to local modulated channel 86 associated with the pressed local channel button 184. Following step 212, the method proceeds to 214 where the method stops.

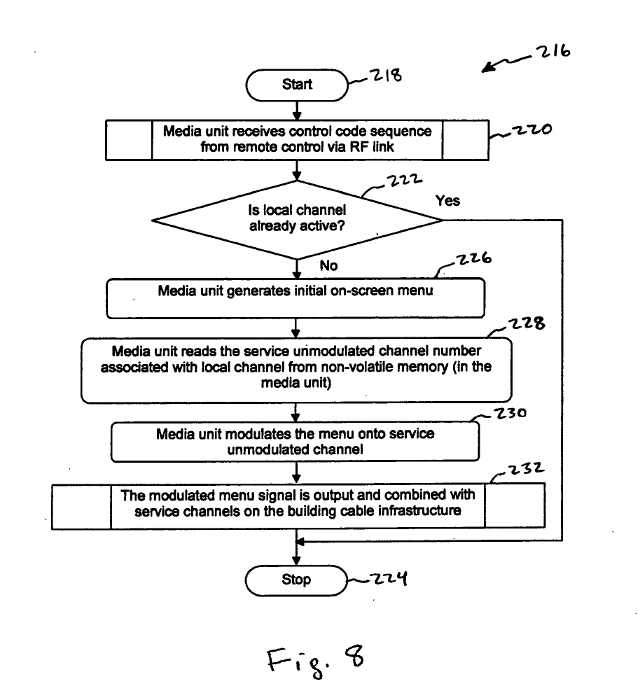

When the selected local channel button 184 is pressed, media unit 52 has different responses depending on whether the associated local channel 86 is active or inactive. An exemplary method 216 is shown in FIG. 8. Method 216 begins at a start 218 from which the method proceeds to step 220. At step 220 media unit 52 receives the control code sequence from remote control 56 which indicates to media unit 52 that one of local channel buttons 184 was pressed and also indicates to media unit 52 which of local channel buttons 184 was pressed. Method 216 then proceeds to a decision at step 222 as to whether local modulated channel 86 associated with pressed local channel button 184 is already active. If the determination at 222 is that the associated local modulated channel 86 is already active then method 216 proceeds to 224 where the method stops. At this point the user may press a button on the remote which will cause the media unit to generate and modulate Initial Menu 192.

If the determination at step 222 is the associated local modulated channel 86 is inactive then method 216 proceeds to step 226. At step 226 media unit 52 generates Initial Menu 192, the method then proceeds to step 228 where media unit 52 determines, from memory, the service unmodulated channel associated with the pressed local channel button 184. Method 216 proceeds to step 230 where media unit 52 modulates the generated menu onto the determined service unmodulated channel to create local modulated channel 86. Method 216 proceeds to step 232 where the created local modulated channel 86 is output and combined with service channels 82 on cable infrastructure 64. Following step 232 method 216 proceeds to step 224 where the method stops.

Media system 50 responds to the press of a single local channel button 184 on remote control 56 to achieve a coordinated response in both media unit 52 and media demodulation device 62 without the user having to remember the channel number for the associated local modulated channel 86 used and without requiring any additional hardware. Multiple users in multiple different rooms 58 can use remote controls 56 to independently coordinate unique menus and display unique content on independent media demodulation devices 62 simultaneously.

In an alternative embodiment, a single press of local channel button 184 any one of remote controls 56 could also include an additional response such that remote control 56 would first transmit a control code sequence through IR link 76 instructing media demodulation device 62 to power on. Methods 200 and 216 could then proceed as described above. This embodiment has the added advantage of utilizing a single button pressed to do everything to power on media demodulation device 62 and display Initial Menu 192.

Remote control 56 stores in memory which of local channel buttons 184 has most recently been pressed so that on subsequent presses to buttons 70 related to menu control and/or media playback control, any resultant action taken by media unit 52 will occur only on the appropriate menu content stream 118 or media content stream 84 (FIG. 2) corresponding to the most recently pressed local channel button 184. For example: if local channel button 184a had most recently been pressed, and menu 68 is being generated/modulated on local modulated channel 86a associated with local channel button 184a and the menu is being displayed on media demodulation device 62a. In this instance when the user subsequently presses one of buttons 70 for menu navigation it is important that media unit 52 modifies only the menu displayed on media demodulation device 62a, and that no modification is made to any other menu which may be currently active on any of the other local modulated channels 86b or 86c.

Pressing buttons 70 related to menu and/or media playback causes remote control 56 to transmit control code sequences to media unit 52 through RF link 72. These control code sequences include two items of information: first is information identifying which of local channel buttons 184a, 184b or 184c was most recently pressed, and second is information indicating which button 70 was just pressed. Media unit 52 receives the control code sequence with the two items of information and applies the appropriate response for button 70 that was just pressed to local modulated channel 86 corresponding to local channel button 184 most recently pressed. By sending information identifying which of local channel buttons 184 was most recently pressed along with controls corresponding to button 70 for media unit 52, media unit 52 is able to apply the controls to the appropriate local modulated channel 86.

It may be necessary in some instances to coordinate control of media demodulation device 62 and media unit 52 when a button 70 is pressed which is ambiguous in that button 70 could be used to control either media demodulation device 62 or media unit 52. One exemplary method for dealing with this situation involves determining if button 70 pressed previous to the ambiguous button press was used to control media demodulation device 62 or to control media unit 52. If the previous button press was used to control media demodulation device 62, then the ambiguous button press is sent to media demodulation device 62 over IR link 76. If the previous button press was used to control media unit 52, then the ambiguous button press is sent to media unit 52 over RF link 72.

In one embodiment, remote control 56 has two general modes or states of operation which are associated with operational states in remote control 56. The first state of operation is a media demodulation device control state 246 and the second state of operation is a media unit control state 248. This embodiment can be realized using a microprocessor and RAM memory in the remote control, or in other manners.

Media demodulation device control state 246 consists of the user controlling one of media demodulation devices 62 with the associated remote control 56 to display content from channel service 80, such as for example, tuning a media demodulation device 62 from one service channel 82 to another by pressing buttons 70 for channel up/down and controlling the volume of the television by pressing buttons 70 for volume up/down. This state of operation involves pressing buttons 70 normally associated with control of media demodulation device 62 and which will cause remote control 56 to transmit only control code sequences associated with media demodulation device 62 through IR link 76. Typical buttons 70 normally associated with the operation of media demodulation device control state 246 include media demodulation device 62 related buttons 70, such as channel up/down and volume up/down, mute and others and include menu related buttons 70 for gaining access to and manipulating setup menus on media demodulation device 62.

Media unit control state 248 consists of a user controlling media unit 52 and media demodulation device 62 with the associated remote control 56 to display menus 68 and/or content on one or more of local modulated channels 86. Media unit control state 248 produces control communications from remote control 56 in response to buttons 70 and/or 184 pressed which can include only RF communications to media unit 52, or can include a combination of RF communications to media unit 52 and IR communications to one or more media demodulation device 62. Media unit control state 248 is entered whenever the user presses one of local channel buttons 184 on remote control 56. Subsequently, remote control 56 remains in media unit control state 248 as long as subsequent button presses occur to only those buttons 70 and/or 184 which have a meaningful relationship to a function in media unit 52. When one or more button 70 is pressed that is normally associated with control of media demodulation device 62, then remote control 56 changes from media unit control state 248 to media demodulation device control state 246. In order to enter back into media unit control state 248 for controlling media unit 52, the user must once again press one of local channel buttons 184 on remote control 56.

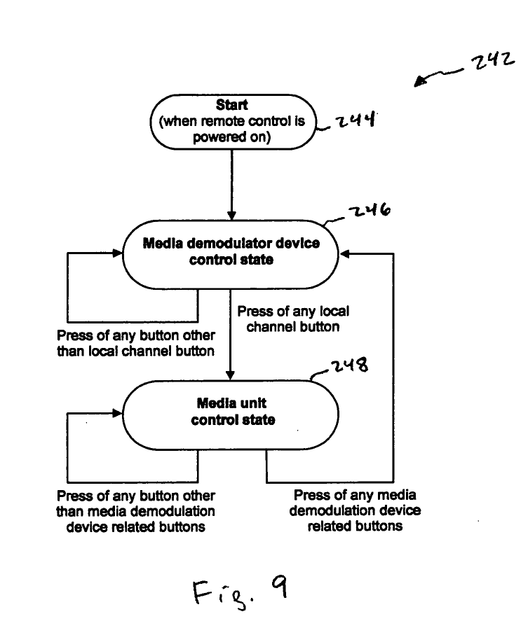

The embodiment using two control states 246 and 248 effectively deals with the problems associated with certain button presses being ambiguous as described. Button presses intended to control media unit 52 occur while remote control 56 is in media unit control state 248 which is entered into by pressing one of local channel buttons 184 on remote control 56. An exemplary method 240 for controlling the states of remote control 56 is shown in FIG. 9. Method 242 begins at a start 244 from which the method proceeds to media demodulation device control state 246. Remote control 56 is initialized into media demodulation device control state 246 and when in control state 246, each of the button presses of remote control 56 are checked to determine if any of local channel buttons 184 have been pressed. As long as button presses are other than one of local channel buttons 184, method 242 remains in media demodulation device control state 246. When any of local channel buttons 184 are pressed, remote control 56 enters media unit control state 248. The method remains in media unit control state 248 so long as every subsequent button press involves a button other than a button 70 related to control of media demodulation device 62. When any of buttons 70 related to media demodulation devices 62 are pressed, method 242 returns to media demodulation device control state 246.

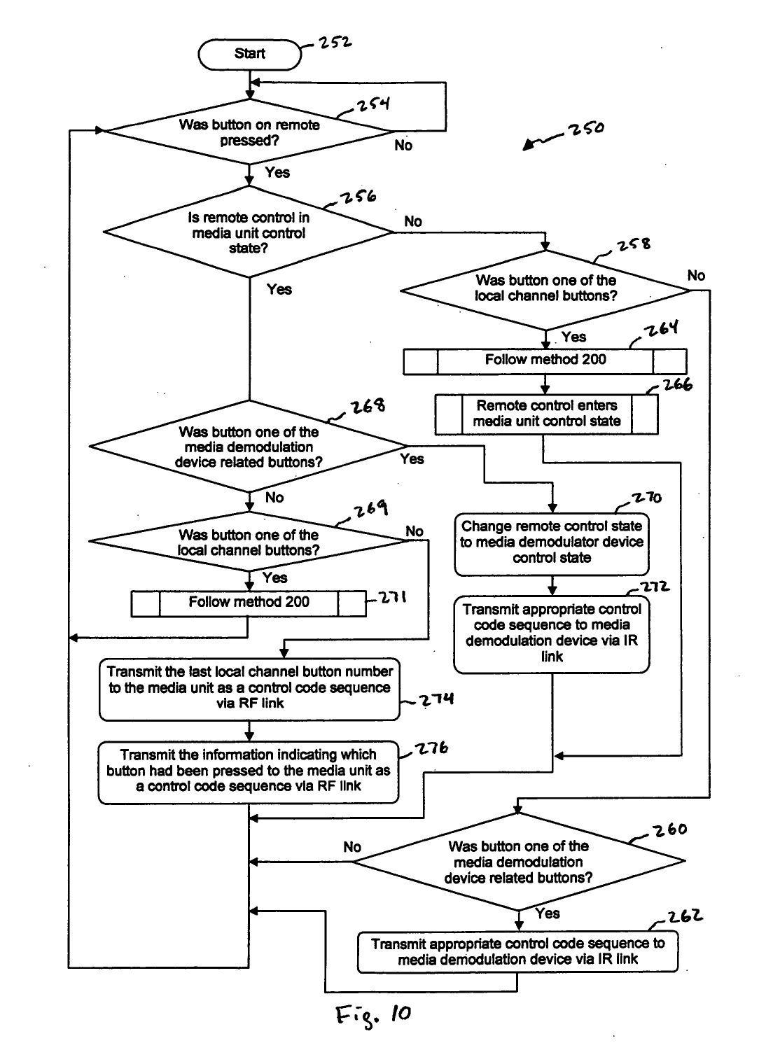

An exemplary control method 250 involving the two control states is shown in FIG. 10. The method begins at a start 252 from which the method proceeds to step 254 where a determination is made as to whether one of buttons 70 or 184 was pressed on remote control 56. If the determination is that a button was not pressed, then step 254 is repeated until a button is determined to be pressed. When the determination at 254 is that a button was pressed, the method proceeds to step 256 where a decision is made as to whether remote control 56 is in media unit control state 248. If the determination at 256 is that remote control 56 is not in media unit control state 248, then the method proceeds to step 258.

At step 258 a determination is made as to whether the button pressed was one of local channel buttons 184. If the determination at step 258 is that the pressed button was not one of local channel buttons 184, then the method proceeds to step 260. At step 260 a determination is made as to whether the pressed button was a button 70 related to control of media demodulation device 62. If the determination at step 260 is that the pressed button was not one of media demodulation device 62 related buttons, then the method proceeds back to step 254 to await another button press. If the determination at step 260 is that the pressed button was one of media demodulation device 62 related buttons, then the method proceeds to step 262 where remote control 56 transmits an appropriate control code sequence to media demodulation device 62 over IR link 76. Following step 262, the method returns to step 254 to await another button press.

If the determination at step 258 is that the pressed button was one of local channel buttons 184 then the method proceeds to step 264 where remote control 56 responds to the pressing of local channel button 184 by storing the number of local channel button 184 and sending a control code sequence to media demodulation device 62 over IR link 76 to cause media demodulation device 62 to tune to local modulated channel 86 associated with the pressed local channel button 184. One example of remote control 56 response to pressing local channel button 184 is method 200 described above. Following the step 264, method 250 proceeds to step 266 where remote control 56 enters media unit control state 248. Following step 266 the method returns back to step 254 where the method awaits another button press.

When a button 70 on remote control 56 is pressed and the determination at 256 is that remote control 56 is in media unit control state 248, then the method proceeds to step 268. At step 268 a determination is made as to whether the pressed button was one of the media demodulation device 62 related buttons 70. If the determination at step 268 is that the pressed button was one of buttons 70 related to control of media demodulation device 62, then the method proceeds to step 270. At step 270, the state of remote control 56 is changed from media unit control state 248 to media demodulation device control state 246. The method then proceeds to step 272 where remote control 56 transmits the appropriate control code sequence to media demodulation device 62 through IR link 76. Following step 272, the method returns to step 254 to await another button press.

When the determination at 268 is that the pressed button was not related to control of one of media demodulation devices 62, then the method proceeds to step 269. At step 269, a determination is made as to whether the pressed button was one of the local channel buttons. If the determination at 269 is that one of the local channel buttons were pressed, then the method proceeds to step 271 where remote control 56 responds to the pressing of local channel button 184 by storing the number of local channel button 184 and sending a control code sequence to media demodulation device 62 over IR link 76 to cause media demodulation device 62 to tune to local modulated channel 86 associated with the pressed local channel button 184, as for example, in method 200. Following step 271, the method returns to step 254 to await another button press.

If the determination at 269 is that the pressed button was not one of the local channel buttons then the method proceeds to step 274. At step 274 the number of the last local channel button 184 pressed is transmitted as a control code sequence to media unit 52 through RF link 72 before the method proceeds to step 276. At step 276, information indicating which button 70 had been pressed is transmitted to media unit 52 as a control code sequence through RF link 72. Following step 276, the method returns to step 254 to await another button press.

The exemplary method 250 represents one possible method of dealing with possible ambiguous button presses on remote controls 56. Other methods of controlling button presses on remote controls 56 and algorithms may also be used.

Menus 68 are utilized to allow the user to accomplish the selection, purchase and download of media content from digital media content provider 66, as well as to allow the user to control playback of the media content on media demodulation devices 62. Menus 68 are generated using a menu generator such as menu systems 280 that are generally implemented in software running on a microprocessor. One output of menu system 280 is digital data which is converted into menu content stream 118 containing the image of the menu, and possibly other things such as a movable cursor. Menu systems 280 are also involved in communications to other portions of media system 50 which cause further actions to occur, such as display of a sub-menu, display of menus of information received from remote content provider 66, starting playback of a media files, among other things. Menu systems 280 typically involves both software and hardware portions and in the present example, menu systems 280 are included in CPU 120.

In the present example, each local modulated channel 86 has a corresponding and independent menu system, which are collectively referred to herein as menu systems 280. In the example shown in FIG. 2, where media unit 52 capable of producing three independent local modulated channels 86 there will be three separate and unique menu systems in menu systems 280, each one corresponding to a different local modulated channel 86.

Various different hardware is capable of running the menu system software portion. In one embodiment, all of the menu system software is running in CPU 120 with each menu system implemented as a separate application or menu task. Each menu task contains capabilities for managing displayed menu content and actions associated with menu manipulation as well as capabilities for taking further actions when appropriate. Multiple menu tasks running on CPU 120 are easily facilitated by the use of a multitasking operating system such as Linux or any other multitasking operating system or multitasking embedded systems software. In the present example, each menu task produces a menu display in the form of digital data 282 which is transmitted from CPU 120 to a corresponding audio/video decoder 144 which converts the data into menu content streams 118. Menu content streams 118 are then sent to the corresponding modulators 150 where streams 118 are modulated onto the corresponding local modulated channels 86 before being combined with service channels 82 on building cable infrastructure 64. Multiple menu content streams 118 can be modulated onto multiple local modulated channels 86 simultaneously and/or at different times. Any one or more of media demodulation devices 62 connected to cable infrastructure 64 can be tuned to any of local modulated channels 86 to display any of menu content streams 118. Other actions required by the user's manipulation of menus 68 are communicated from the menu task to other tasks running on CPU 120 which causes the actions to be taken.

An alternative embodiment makes use of the fact that modern audio/video decoder ICs contain microprocessors capable of running a menu task. For example, single chip audio/video decoder devices such as the Sigma Designs EM8510 contains an embedded microprocessor and also incorporate built-in on-screen display (OSD) functions such that an on-screen menu can be easily generated and placed onto the decoded output stream. In this example, the menu task is implemented in software running on the embedded microprocessor and is implemented in such a way as to utilize the built-in and OSD functions. Each decoder contains only the single menu task which is corresponding to that decoder. The menu task receives button press information from CPU 120 and the menu task utilizes various software and hardware in the decoder to generate the menu content streams. The menu content streams are then sent to the corresponding modulators where the streams are modulated onto the corresponding local modulated channels before being combined onto the cable infrastructure. The user's manipulation of the menu is communicated between the menu task and the CPU.

In another example, a portion of each of the menu tasks are running on the corresponding decoders while the remaining portion of each menu task is running as a separate task in the CPU. In this instance the split parts of each menu tasks operate cooperatively by communication of data between the CPU and each decoder.

Regardless of the embodiment chosen for the menu tasks, media unit 52 also coordinates and directs information about button presses from remote controls 56 to the correct menu task. For example, if a user presses local channel button 184a on any of remotes 56, and then presses a button 70 related to a menu control, the information about which button 70 that was been pressed must be communicated ultimately to the menu displayed on local modulated channel 86a which corresponds to local channel button 184a in the present example. This coordinated communication is accomplished in the example discussed in conjunction with FIG. 10.

A separate software task, called a director task, runs on CPU 120 and receives the control code sequence from RF receiver 134 over RF receiver line 135 and directs the control code sequence to the appropriate menu task. The director task involves a method 300 that is implemented in software in the present example for media unit 52 shown in FIG. 2 which is capable of producing three separate local modulated channels 86a, 86b and 86c. Other director tasks can be used for directing control code sequences from RF receiver 134 to the appropriate menu task, and the number of instances of the director tasks can be modified for media units capable of producing more or less local modulated channels than the example media unit shown in FIG. 2.

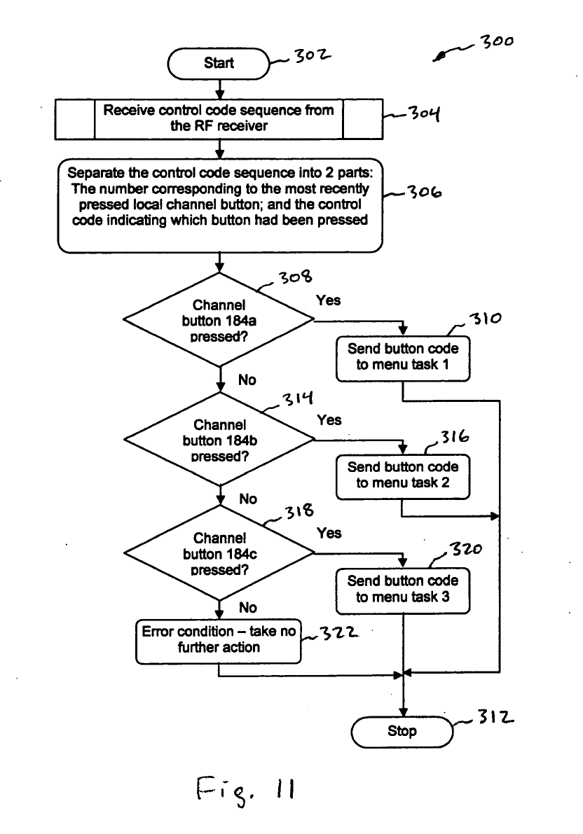

Method 300, shown in FIG. 11, begins at a start 302 from which the method proceeds to step 304. At step 304 a control code sequence is received from RF receiver 134. Following step 304, the method proceeds to step 306 where the control code sequence is separated into two parts: one part having the number corresponding to the most recently pressed local channel button 184, and the other part having a button code indicating which button 70 was pressed. The method proceeds to step 308 where a determination is made as to whether the most recently pressed local channel button 184 was local channel button 184a. If the determination at step 308 is that the most recently pressed local channel button was local channel button 184a, then the method proceeds to step 310. At step 310 the button code is sent to the menu task for local modulated channel 86a corresponding to a local channel button 184a. Following step 310, the method ends at step 312.

If the determination at 308 is negative, then the method proceeds to step 314 where a determination is made as to whether the most recently pressed local channel button 184 was local channel button 184b. If the determination at step 314 is that the most recently pressed local channel button 184 was local channel button 184b, then the method proceeds to step 316 where the button code is sent to menu task for local modulated channel 86b corresponding to local channel button 184b. Following step 316, the method ends at step 312.

If the determination at 314 is negative, then the method proceeds to step 318 where a determination is made as to whether the most recently pressed local channel button 184 was local channel button 184c. If the determination at step 318 is that the most recently pressed local channel button 184 was local channel button 184c, and the method proceeds to step 320 where the button code is sent to the menu task for local modulated channel 86c corresponding to local channel button 184c. Following step 320, the method ends at step 312.

If the determination at step 318 is negative, then the method proceeds to step 322 where an error condition is determined to have occurred and the method takes no further action involving the present received control code sequence. Following step 322, the method ends at step 312.

In the present example, a non-media demodulation device-related button press on any one of remotes 56 which is in media unit control state 248 will cause the menu task corresponding to the most recently pressed local channel button 184 on remote 56 to receive information which indicates which button 70 had been pressed. For example, if a user presses local channel button 184a on remote control 56b to display a menu on local modulated channel 86a, then subsequent button presses which are not media demodulation device related will be directed to the menu task for controlling the menu on local modulated channel 86a. In this way the user is able to interact with and control the menus using remote controls 56.

Playback of the media content is accomplished when menu task communicates with a playback task running on CPU 120 requesting that the digital content media file be accessed from data storage device 132. The digital content media file is communicated from data storage device 132 to CPU 120 and then from CPU 120 to audio/video decoder 133. The digital content media file is accessed and communicated sequentially in accordance with its structure and also in accordance with its data rate so that the data is received by audio/video decoder 144 at the correct speed for playback. A buffer (not shown) is used to buffer some of the data locally in audio/video decoder 144 and in CPU 120 so that temporary pauses in data access from data storage device 132 do not cause pauses in the playback presented to the user. Content streams 84 from decoders 144 are modulated onto local channels 86 and combined into building cable infrastructure 64 where any of media demodulation devices 62 can tune to one or more local channels 86 and display one or more content streams 84.

Menus 68 allow the user to select, purchase and download digital media content from digital media content provider 66 by pressing buttons 70 on any of remote controls 56. Media unit 52 interacts with a digital content provider 66 so that the menus display information relating to the available media content from digital content provider 66. In one example the menu tasks communicate bi-directionally with digital media content provider 66 using cable modem 164. The information communicated bi-directionally uses a predetermined protocol which both the menu tasks and digital media content provider 66 follow. For example if the user presses a button sequence on remote control 56 to access a content-for-purchase list from media content provider 66, information requesting the list can be sent from the menu task in media unit 52 to digital media content provider 66 through cable modem 164. In response, digital media content provider 66 sends the list of content available back to media unit 52 in some predetermined format. The menu task in media unit 52 would receive and display all or some of the list according to a predetermined menu design.

In another example, the menu task displays menu 68 which has been supplied directly from digital media content provider 66. In this instance, information from digital media content provider 66 contains graphic objects and instructions for what is to be displayed on menu 68. The menu task receives the graphic objects and instructions and creates the appropriate menu 68 for display. One instance of this type involves web browsers which operate to display web pages based on HTML information received from the web server.

Menus 68 allow the user to access digital media content for purchase and for playing over cable infrastructure 64. The construction and/or layout of the menus for purchase allow the user to access digital media content provider 66 to select, purchase and download media content and the construction and/or layout of the menus for playing the media content allow the user to select media content stored on data storage device 132 and play back the selected media content on one or more media demodulation devices 62 connected to cable infrastructure 64.

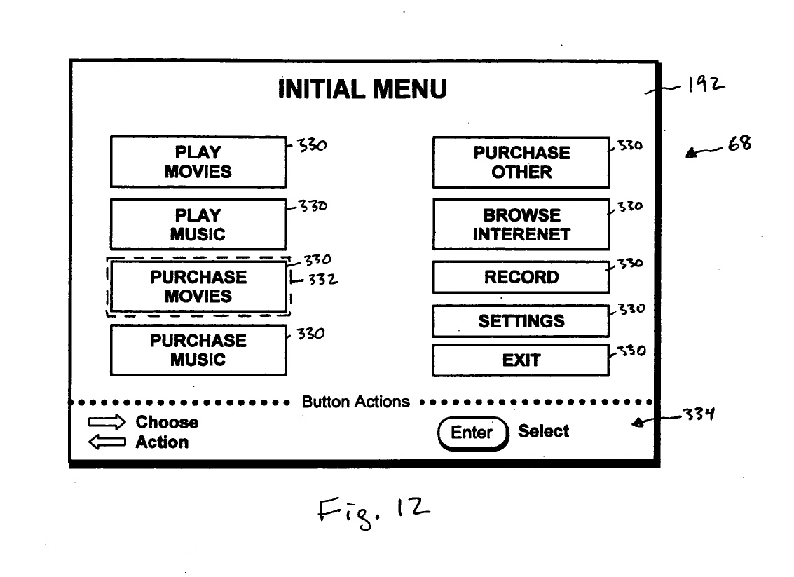

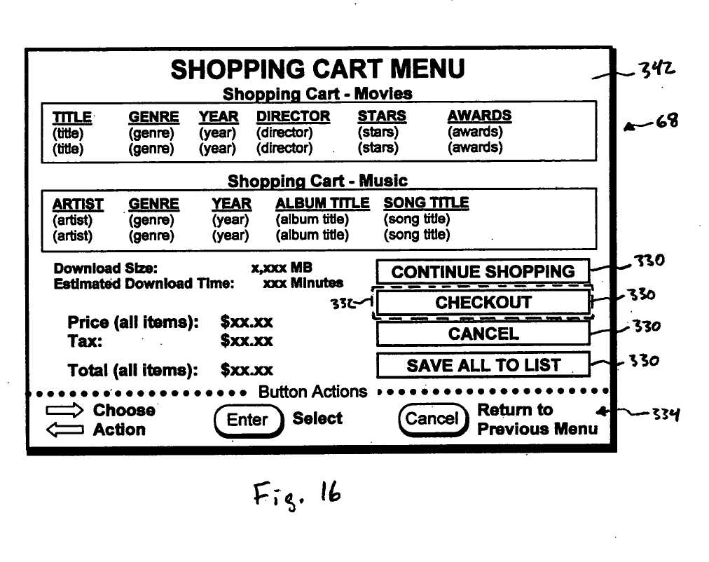

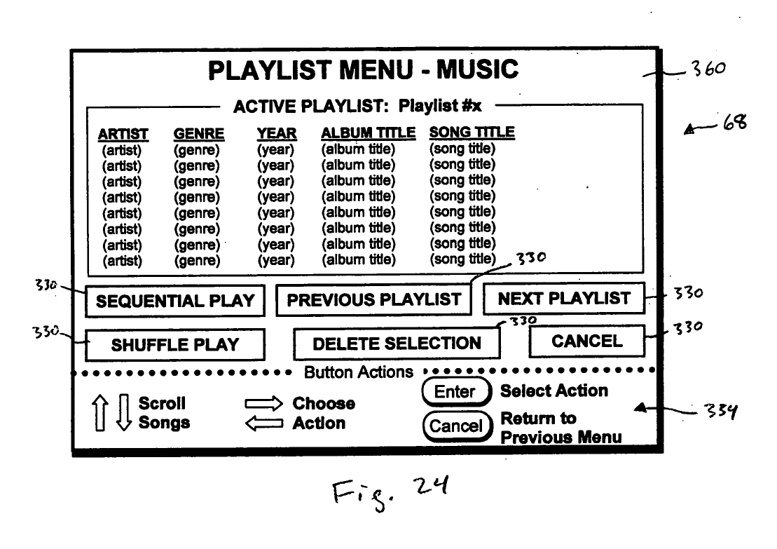

Exemplary menus 68 are shown in FIGS. 12-24. Initial Menu 192 is shown in FIG. 12 for allowing the user to access different functions of media system 50. In the present example navigation of menus 68 are accomplished by selecting menu items 330 which are highlighted 332 as represented by dashed lines. Highlight 332 is moved from one menu item 330 to another using buttons 70, which may include 4-way navigation buttons, on remotes 56 and the highlighted menu item 330 is selected by pressing an enter one of buttons 70 on the remote. In Initial Menu 192 shown in FIG. 12, a purchase movies menu item is highlighted. Some or all of menus 68 also include legends 334 to remind the user which buttons 70 are used to navigate and select menu items 330 as well as other things.

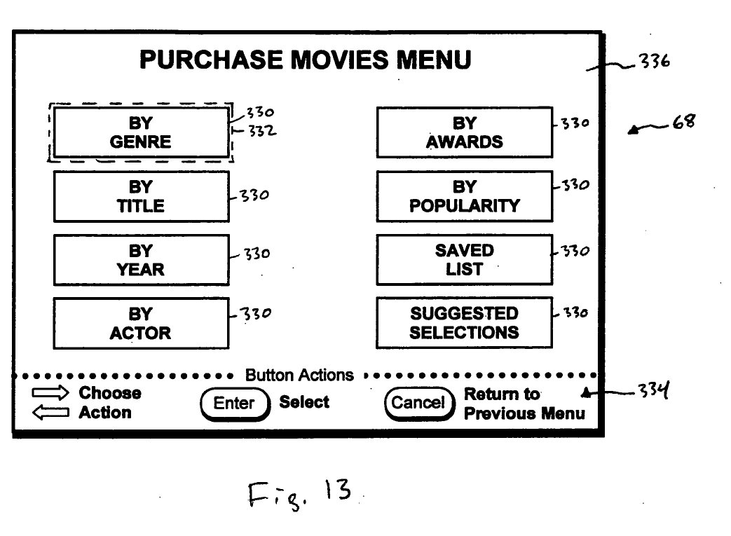

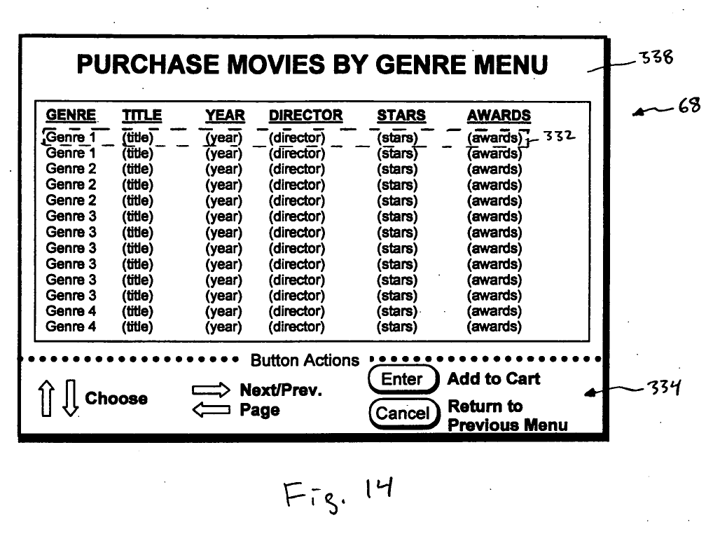

Selecting the purchase movies menu item in Initial Menu 192 causes a Purchase Movies Menu 336, (FIG. 13), to be displayed. Purchase Movies Menu 336 allows the user to select from various titles of movies based on such metrics as genre, title, year, actor, awards, popularity, saved list and/or suggested selections among other things. Selecting the be genre menu item brings up a Purchase Movies By Genre Menu 338, (FIG. 14). In this menu 338, the user is able to select a movie based on a search by genre and add the movie to a list for purchase by highlighting and selecting the desired movie. Lists containing information such as those shown in menu 338 and others are typically retrieved from digital media content provider 66 prior to the generation of the menu.

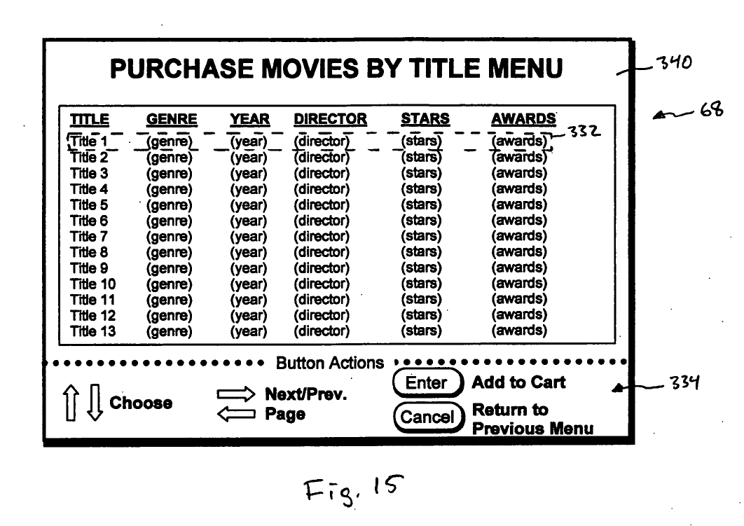

An exemplary Purchase Movies by Title Menu 340, shown in FIG. 15, is also reached through Purchase Movies Menu 336. Purchase Movies by Title Menu 340 allows the user to search a list of titles available for purchase and download based on the title of the movie. The user is able to select the movie for purchase by highlighting 332 the movie on the list and pressing the enter button 70.

Another set of menus 68 can be provided for selecting music or other media content to purchase. These purchase music menus (not shown) could allow the user to select music files based on genre, artist, album title, song title, year, popularity, saved list and/or suggested selections among other things.

Each time a media content file is selected for purchase from the Purchase Movies Menus by genre or by title menus 338, 340 or others, a Shopping Cart Menu 342 is displayed. Shopping Cart Menu 342 lists the media content that has been selected and offers menu items 330 which allow the user to continue shopping, checkout, cancel or save all to a list. Shopping Cart Menu 342 also includes a total cost of all of the media content selected for purchase and can include other information. The user selects the continue shopping menu item to select more media content for purchase. The user selects the cancel menu item to cancel the purchase of one or more of the content files. The selected media content can be added to a list for purchase at another time by selecting the save all to a list menu item.

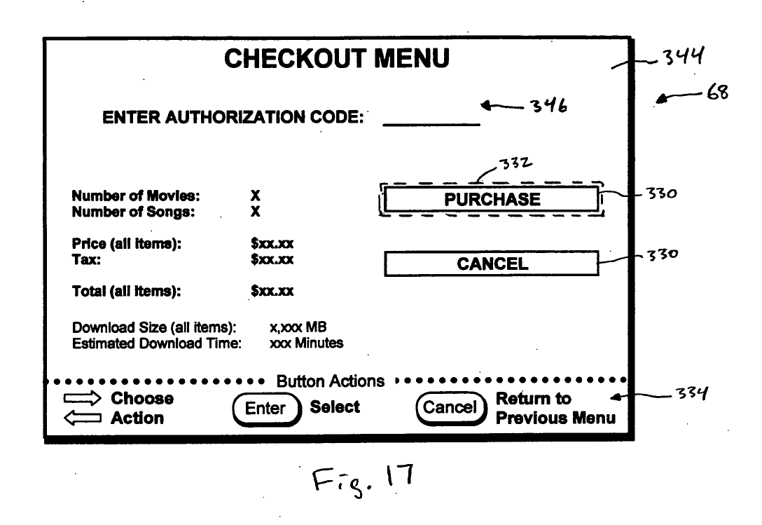

When the user is ready to purchase the selected one or more media files, the user highlights 332 and selects checkout menu item 330 from Shopping Cart Menu 342 which causes a Checkout Menu 344 to be displayed. Checkout Menu 344 shown in FIG. 17, lists the number of media content files and the price including tax (if any). The Checkout Menu also includes a download size and estimated download time display portions. An optional authorization code line 346 is shown which allows the user to enter an authorization code to prevent unauthorized purchase of media content onto media unit 52. This menu 344 may also have an optional feature for selecting the compression format or other qualities of the movie to be purchased. When the user is ready to purchase and download the media content, the user highlights 332 and selects purchase menu item 330. Once the movies are purchased, the movies are automatically downloaded to data storage device 132 in media unit 52 and Initial Menu 192 is again displayed.

Downloading the digital media content from digital media content provider 66 is accomplished in the present example in a manner similar to the way in which Internet connected PCs download files from a remote source. Software running in CPU 120 of media unit 52 communicates cooperatively with digital media content provider 66 to cause digital media content in to be received and subsequently written to data storage device 132 in such a manner that the media content can be accessed and read back at a later time. Media unit 52 may include digital rights management capabilities as needed.

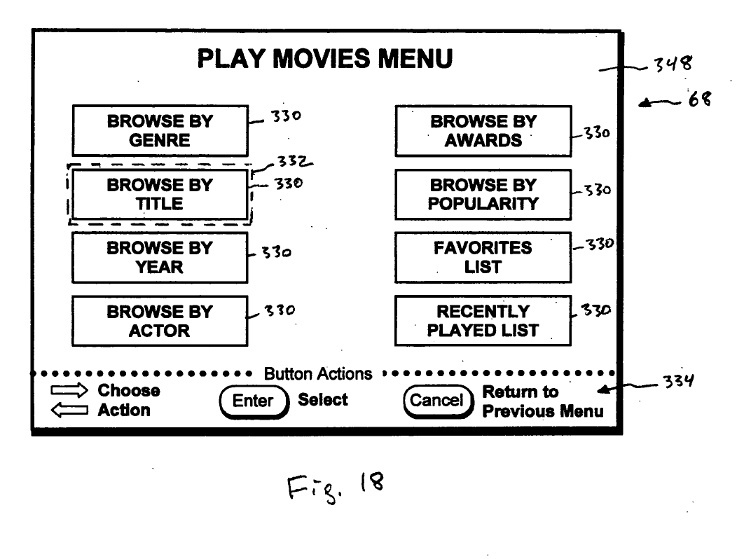

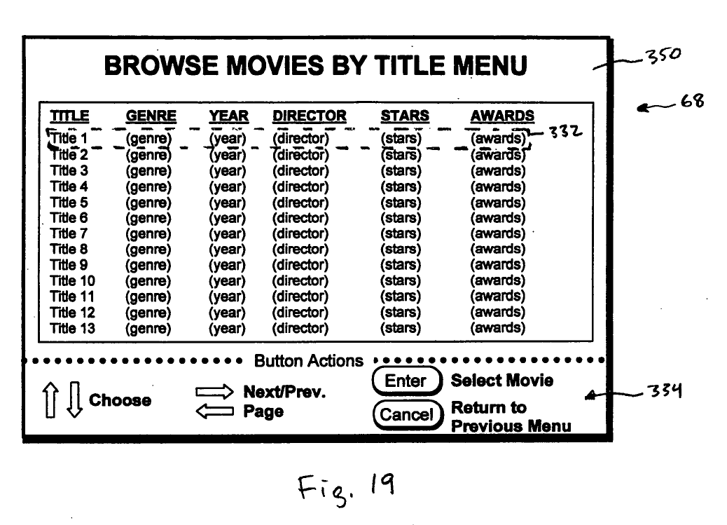

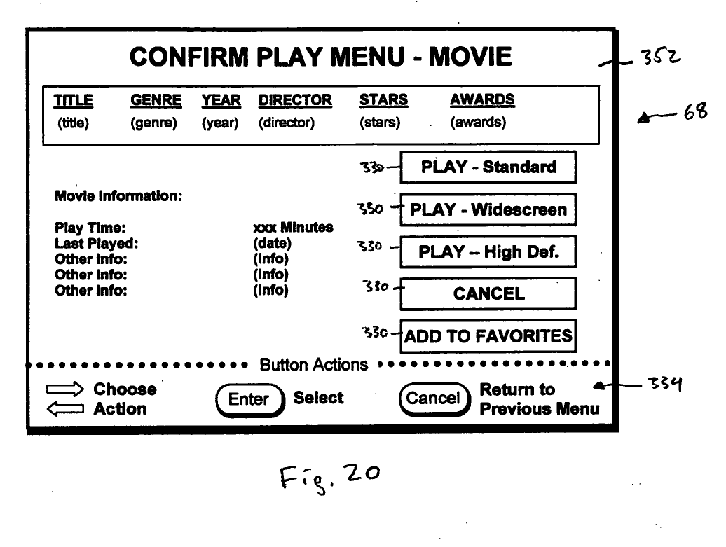

Playback of the digital media content is controlled using menus 68 which also start with Initial Menu 192 in the present example. Selecting play movies menu item 330 from Initial Menu 192 causes a Play Movies Menu 348, FIG. 18, to be displayed. Play Movies Menu 348 allows the user to select movies for playing based on: genre, title, year, actor, awards, popularity, favorites list, recently played last and/or other things. Selecting browse by title menu item 330 brings up a Browse Movies by Title Menu 350, as shown in FIG. 19. Once a movie is selected in this menu 350, a Confirm Play Menu 352 (FIG. 20) is displayed. Confirm Play Menu 352 allows the user to select the format for playing the selected movie and may also provide more detailed information about the movie and have menu items 330 for canceling and/or adding the movie to a favorites list, among other things. Selecting one of the play menu items 330 causes media unit 52 to begin playing the media content on the local modulated channel which was previously displaying Confirm Play Menu 352.

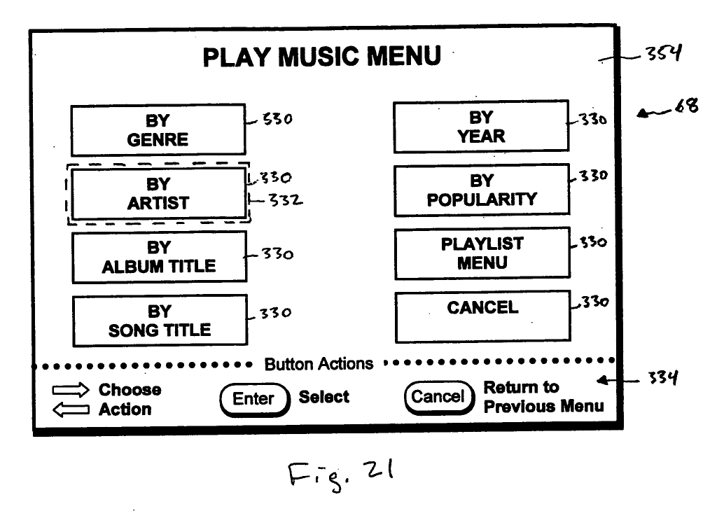

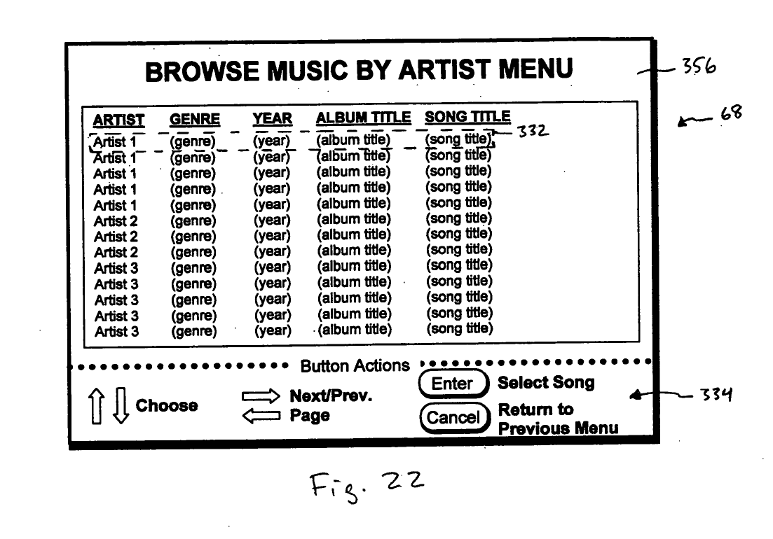

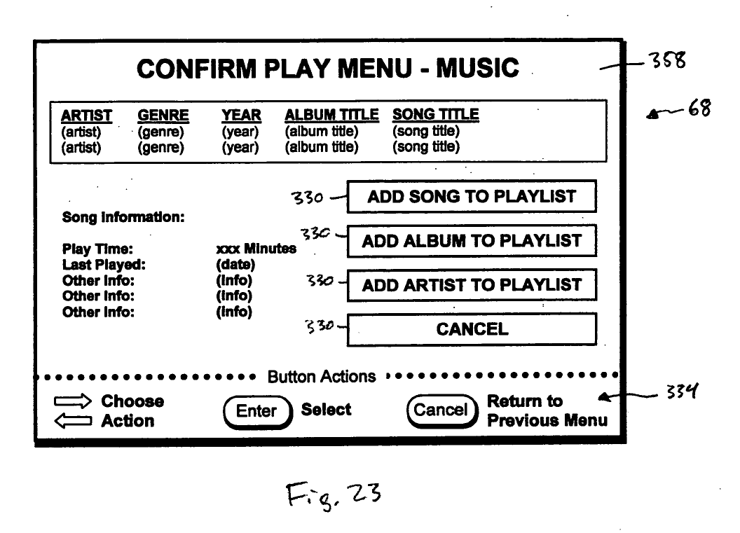

A Play Music Menu 354, as shown in FIG. 21, is also accessed from Initial Menu 192 in the present example. Play Music Menu 354 allows the user to search based on: genre, artist, album title, song title, year, popularity and/or other things. Play Music Menu 354 may also include a playlist and cancel menu items 330. Selecting the browse music by artist menu item 330 displays a Browse Music by Artist Menu 356, as shown in FIG. 22. This menu 356 allows the user to select songs to be played. Selecting a song causes a Confirm Play Menu 358, (FIG. 23) for music to be displayed. Confirm Play Menu 358 includes a playlist of songs and menu items 330 for adding songs, albums, and artists to the playlist. Other information may also be included in Confirm Play Menu 358 such as listing the last time the present playlist was played, and the total play time of the present playlist among other things.

Selecting playlist menu item 330 from Play Music Menu 354 causes a Playlist Menu 360 to be displayed. Playlist Menu 360 for music allows the user to browse through and select a playlist for playing on media unit 52. The Playlist Menu also allows the user to sequentially play or shuffle play the playlists.

The foregoing menus shown in FIGS. 12-24 are exemplary of menu which may be used for purchasing and downloading media content from digital media content provider 66 and for playing media content with media unit 52. Other menus may be substituted for those disclosed as long as the substituted menus allow media content to be purchased, downloaded and played with media unit 52 using remotes 56.

In some instances it is advantageous to make local channels 86 inactive so that a user may receive Initial Menu 192 when pressing a local channel button 184. For example, if a user on a first day, views content on local channel 86a and completes viewing the content, then another user on a later day accesses local channel 86a by pressing local channel button 184a on one of remote controls 56, then it is advantageous that Initial Menu 192 is displayed as opposed to displaying media content or menu 68 related to what has been viewed on the first day. To ensure Initial Menu 192 will be displayed under this condition, media unit 52 automatically makes a local channel change from active to inactive under certain conditions. One such condition is where some predetermined amount of time has elapsed after the media file has finished playback and during which time no control code sequences have been received which correspond to this local channel; another such sequence is where some predetermined amount of time has elapsed after a menu has been displayed with no subsequent control code sequences have been received which correspond to this local channel. These and similar conditions are referred to as “timeouts” which could be implemented in software algorithms running on CPU 120 of media unit 52. Other methods may be implemented to allow the user to force local modulated channel 86 to the inactive state, for instance when the user accesses Initial Menu 192 and selects the exit menu item.

Media system 50 allows multiple users to have independent access to and control of menus and content streams from media unit 52 through the use of identically designed remote controls 56 in an intuitive and natural manner. The following examples illustrate how this is accomplished by media system 50 shown in FIG. 1.

In the first example there are three users: user 1 is located in room 58a, user 2 is located in room 58b and user 3 is located in room 58c. Also, the starting condition is that all three local modulated channels 86a, 86b and 86c are inactive.

User 1 presses local channel button 184a on remote control 56a located in room 58a, which brings up Initial Menu 192 on media demodulation device 62a located in room 58a. User I then interacts with the menu system to select and begin playing media content on local channel 86a.

While user 1 is watching the media content on local channel 86a, user 3 presses local channel button 184c on remote control 56c located in room 58c, which brings up a copy of Initial Menu 192 on media demodulation device 62c located in room 58c. User 3 then interacts with menu 192 by pressing a sequence of menu related buttons to access remote digital media content provider 66, then selects a media file for purchase, and makes a purchase and begins download of the file. As the media file is being downloaded, the user 3 begins play back of the media file by further interacting with menu 192.

While user 1 is watching the media file on local modulated channel 86a and user 3 is watching another media file on local modulated channel 86c, user 2 presses local channel button 184b on remote control 56b located in room 58b, which brings up a copy of Initial Menu 192 on media demodulation device 62b located in room 58b. User 2 interacts with menu 192 by pressing a sequence of menu related buttons to select and start media file playing on local modulated channel 86b.

While users 2 and 3 are each watching media files, user 1 is able to press a pause one of buttons 70 on remote control 56a located in room 58a which causes the media file playback on local modulated channel 86a to pause. Later, user 1 presses the play one of buttons 70 which causes the media file playback on local modulated channel 86a to continue.

At this point, all three users, each being in separate rooms 58a, 58b and 58c at separate media demodulation devices 62a, 62b and 62c used identically designed remote controls 56a, 56b and 56c to access and interact with separate and independent menus generated by the single media unit 52 in order to select, purchase, download and playback digital media content.

Another example illustrates how media system 50 provides seamless access to content throughout multiple rooms 58a, 58b and 58c of house 60. In this example, there are two users: user 1 is initially located in room 58a, and user 2 is located in room 58b. This example also assumes the starting condition that all three local modulated channels 86 are inactive.

User 1 presses local channel button 184a on remote control 56a located in room 58a, which brings up a copy of Initial Menu 192 on media demodulation device 62a located in room 58a. User 1 interacts with the copy of menu 192 by pressing a sequence of menu related buttons to select and start a media file playing on local modulated channel 86a.

While user 1 is watching the media file on local modulated channel 86a, user 2 presses local channel button 184b on remote control 56b located in room 58b, which brings up a copy of Initial Menu 192 on media demodulation device 62b located in room 58b. User 2 interacts with the menu by pressing a sequence of menu related buttons to select and start a media file playing on local modulated channel 86b.

At a later time, user 1 presses the pause button to pause playback on local modulated channel 86a. Then, user 1 relocates to room 58c. User 1, using remote control 56c, presses local channel button 184a, which causes the paused content playback on local channel 86a to be displayed on the media demodulation unit in room 58c. User 1 presses the play button on remote control 56c to resume playback of the media content on local modulated channel 86a in room 58c.

This second example illustrates that multiple media and demodulation devices 62 can be coordinated to control and/or display the same content stream 84 by use of remote controls 56.

Media unit 52 of media system 50 can also have one or more other optional features. In one instance, media unit 52 could also function as a set top box for receiving digital cable service from a channel service. In this instance, cable modem 164 or another device can receive multiple digital content streams from channel service 80 and CPU 120 directs the content streams to the various local channels 86 under the control of multiple users using remote controls 56. In this manner, a single media unit 52 replaces multiple cable set-top boxes throughout house 60 providing a reduced cost and installation complexity.

Another optional feature allows a single media unit 52 to receive and down-convert HD broadcasts to allow non-HD compatible media demodulation devices 62 to receive and display them. In this instance media unit 52 contains one or more high-defintion (HD) receivers for on-air and/or on-cable HD broadcasts. The output of the HD receivers could be down-converted into conventional television signals using the existing audio/video decoders 144 and modulators 150. The down-converted signals can then be sent to media demodulation devices 62 throughout house 60 for demodulation and reproduction of the audio/video as non-HD media. As more and more broadcasts are made in HD format, consumers owning multiple non-HD compatible media demodulation devices would still be able to use view service channels without having to reinvest in replacement HD compatible media demodulation devices 62.

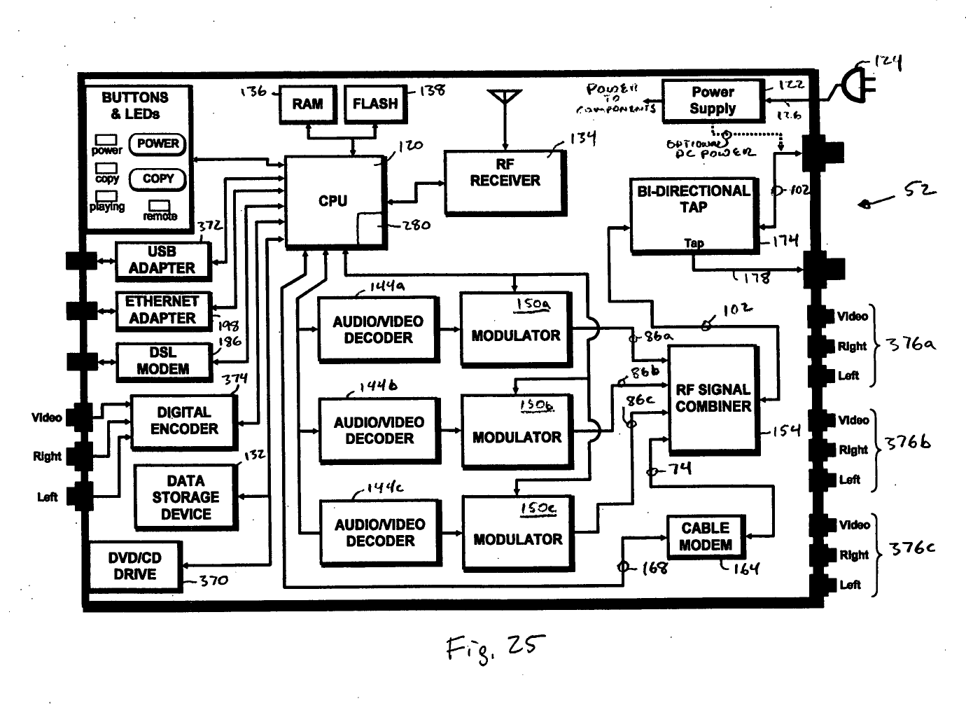

In another optional feature, shown in FIG. 25, media unit 52 can include an internal DVD drive 370. DVD drive 370 allows DVD discs to be accessed and played using the same or a different menu system which accesses and plays the digital content stored in a data storage device 132. This feature allows media unit 52 to function as a centralized DVD player which can be accessed, controlled and viewed from any television in the house. DVD drive 370 can also include a ripping function for copying content from DVD discs onto data storage device 370 for later playback. In addition, or alternatively, a separate DVD player may be connected to media unit 52 for control by and playing through the media unit over one or more of the local modulated channels. In this instance media unit 52 can pass control codes to the DVD player to control playback and menu and other functions of the DVD player.

Yet another optional feature includes a USB or other port and adaptor 372 for connecting and accessing personal storage devices, MP3 players, phones and other devices. Content from these devices can be accessed and played from media unit 52 using the same or a similar menu system used for accessing and playing the digital content stored on data storage device 132. This feature allows media content stored on any of the above devices to be accessed, controlled and viewed or otherwise reproduced from any of media demodulation devices 62 in house 60. USB port 372 can also be used for connecting to a network adapter in order to provide access to the Internet. One reason for connecting to the Internet would be if digital content provider 66 was Internet-based.

Another optional feature is the inclusion of ethernet port 198 in addition to or as a replacement for cable modem 164. Media unit 52 may contain ethernet port 374 for connecting and/or accessing to a LAN or some other type of modem. In this instance, it may be possible to eliminate cable modem 164.

Another example of a configuration in which it may be possible to eliminate the cable modem involves using DSL modem 186. In this instance digital media content provider 66 would be connected to transmit and receive information with media unit 52 through phone line 187.

Media unit 52 may also include an audio/video input connected to a digital encoder 374 which is able to convert analog audio/video signals into encoded digital format. For example, the digital encoder may encode the analog audio/video signals into MPEG-2, MPEG4 or another digital encoding format. The digitally encoded audio/video material may then be stored on data storage device 132.

In yet another optional feature, media unit 52 may include one or more audio/video outputs 376 for connecting media unit 52 directly to a nearby television or video display device.

In the media system described herein, each and every media demodulation device 62 in house 60 or other building can be used as an independent point of access for purchase and playback of digital media content without requiring any special adapters or devices at each media demodulation device 62 other than the identically designed remote controls 56. Independent points of access to content available for purchase from each and every media demodulation device 62 are created in house 60 or other type of building in a simple low-cost and easy to set-up manner.

Another optional feature adds a Digital Video Recorder (DVR) function to the media unit, such that content streams on service modulated channels can be recorded and stored to the data storage device 132 as media files. Subsequently a user can access and play-back said media files as described previously.

In particular, a digitally-controlled tuner, a demodulator, and an encoder are incorporated into the media unit such that the tuner receives the service channels 82. A user interacts with additional menus using the remote control, adjusting the tuner to a selected service modulated channel via communication of control code sequences from the remote control to the CPU which in response adjusts the tuner to the appropriate channel. The output from the tuner is demodulated into video and/or audio signals, which are then encoded into a digital format such as MPEG-2 or MPEG4. The encoded data is then stored on the data storage device 132 as a media file for playback as described previously.

Another optional feature allows the media unit to automatically identify which service channels are service unmodulated channels, to identify preferred service unmodulated channels for use as local modulated channels by the media unit, and to automatically select the preferred service unmodulated channels for use as local modulated channels. Futhermore, an additional optional feature allows the media unit to communicate information about the selected local modulated channels to the remote controls. These features in combination eliminate the need for a user to perform any initial set-up of the media unit or remote controls with respect to channel selection for the local modulated channels, therefore causing the media system to be much easier to install and set-up.

In particular, a digitally controlled tuner and signal measurement device are incorporated into the media unit such that the tuner receives the service channels 82. At various times the media unit performs a scanning operation and tunes to each and every FCC allocated channel for broadcast or cable television, measuring one or more suitable characteristics of the signal within the tuned frequency range. One exemplary characteristic would be the amplitude of the tuned signal. Using these measurements, the media unit executes an algorithm to identify which channels are most suitable for use as local modulated channels, and subsequently assigns the local modulated channels to use these. In addition, bi-directional RF communication capability is incorporated into the media unit and remote controls, such that the media unit is able to communicate information about the channels selected for use as local modulated channels to the remote controls, in addition to the communication of control code sequences from the remote controls to the media unit as described previously. The remote controls receive the information communicated from the media unit and use it to automatically tune the media demodulation devices to the correct channel, corresponding to the channel previously selected by the media unit, when any of the local channel buttons are pressed.

Another optional feature allows remote controls, which incorporate bidirectional RF communication to the media unit as described previously, to control both the media demodulation devices 62 and additionally one or more other devices via IR or RF communications, making the remote controls more generally useful.

In particular, the remote controls incorporate bidirectional RF communications for communicating with the media unit and also incorporate one or more additional buttons 70 called “other device selection buttons” which are specifically related to one or more devices, other than the media demodulation devices. Such other devices may include but are not limited to DVD players, satellite receivers, set-top boxes, stereo systems, and systems to control various appliances in the home. Two other selection buttons are optionally incorporated, one relating to the media unit and the other relating to the media demodulation device, these together with the other device selection buttons are referred to as “device selection buttons”. When a device selection button is pressed, the remote control switches to a mode of operation consistent with controlling the device related to the particular selection button pressed, similar to how a universal remote control operates. During initial set-up, the user programs the remote control in a manner similar to programming a universal remote control such that during normal operation control code sequences produced by the remote control after a particular other device selection button has been pressed correspond to control code sequences used by a particular brand and model of other device.

Another optional feature allows remote controls to recognize individual users and transmit secure user authenication information to the media unit. This feature is used to enhance the remote control's capability for selecting and purchasing content, and can also enhance the remote control's usefulness in performing other functions such as restricting access to content files stored in the media unit, securely accessing personal files stored on internet connected servers, or accessing purchased media files stored in remote locations.

One example of the enhanced usefulness of this optional feature is when the media system is being used to purchase content. Typically at the time of purchase, a user would need to transmit payment information to the digital content provider such as a credit card number and expiration date in order to complete the purchase. Such payment information would need to be entered by the user for each and every purchase transaction. However with this optional feature the user would need only enter the credit card information during a one-time setup, after which the recognition and authentication means would automatically transmit the credit card information to complete each purchase.

In particular, each remote control optionally incorporates a recognition device for uniquely identifying the individual utilizing the remote control, bi-directional RF communications, and an authentication system to communicate the recognition information in a secure manner to the media unit. Examples of recognition devices include biometric security devices and/or codes/passwords entered into the remote control by the user. As is typical with user authentication methods, the media unit and remote control will operate cooperatively through the bi-directional RF communication means such that in the case where authentication is required, the user can perform a simple/quick action such as a finger swipe on a fingerprint scanner to authorize a purchase, gain access to restricted content files, or gain access to files stored remotely to the media unit in a secure manner.

Another optional feature involves the remote controls containing local channel buttons such as described previously, could be used in media systems which distribute content streams to media demodulation devices via using systems other than modulated local channels on cable infrastructures. For example, the media unit might distribute content streams to media demodulation devices via a wireless network as opposed to a cable infrastructure, where the media demodulation devices incorporate capabilities to receive and demodulate the wireless network signals. In this case the function and use of the local channel buttons as described previously would still be advantageous.

In particular, the remote controls would be constructed and operate as described previously. Communication from the remote controls to the media demodulation devices would operate as described previously, and communication from the remote controls to the media unit would operate as described previously. However the initial set-up of the remote controls and media unit would not need to include anything related to identification and selection of local modulated channels, and instead the initial set-up would consist of such actions as necessary to create the capability for any press of a local channel button on a remote control to cause the same end results in the media system as described previously.

Another optional feature allows the user to select media content from a remote source and instead of saving the content to the data storage device, the media content is played back in a real-time streaming manner. This feature allows the user to view content without consuming capacity in the data storage device, and may also facilitate access to remote content where the content owner authorizes real-time viewing, but not storage, of the content.

In particular, the media system would operate substantially as previously described with the exception that the remote content is routed from the remote source, to an audio/video decoder within the media unit without first being stored on the data storage device in a permanent manner. As is typical with playback of streaming content, a buffer memory might be employed to first store a portion of the content stream and then playback would occur out of the buffer memory in a first-in-first-out manner in order to reduce unwanted playback pauses due to temporary delays in the transmission of the content stream from remote source to the media system.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for loading media content from a remote source to a centralized media unit for selective distribution on a cable infrastructure to a plurality of media demodulation devices connected to the cable infrastructure, the method comprising:
connecting the media unit to the remote source of media content through a single connection;
generating a menu by the media unit, the menu including information relating to the media content on the remote source;
distributing the menu from the media unit to the plurality of media demodulation devices on the cable infrastructure;
displaying the menu on at least one of the media demodulation devices;
selecting at least some of said media content for downloading from the remote source by interacting with the media unit and any given one of the plurality of media demodulation devices displaying the menu, and where the selected media content is indicated to the remote source through the single connection;
downloading the selected media content from the remote source to the centralized media unit through the single connection; and
generating a plurality of simultaneous content streams, based at least partially on the selected media content, by the centralized media unit and distributing the streams on the cable infrastructure to the plurality of media demodulation devices.

2. A method as defined in claim 1 wherein the plurality of simultaneous streams includes a stream of media content created with the downloaded selected media content.

3. A method as defined in claim 1 wherein the media unit is connected to the remote source using only a single telephone communications connection.

4. A method as defined in claim 1 wherein the media unit is connected to the remote source using only a single coaxial cable connection.

5. A method as defined in claim 1 wherein the media unit is connected to the remote source using only a single internet connection.

6. A method as defined in claim 1 wherein the media unit is connected to the remote source using only a satellite dish.

7. A method as defined in claim 1 wherein the media unit includes an Ethernet port and the media unit is connected to the remote source of media content using the Ethernet port.

8. A method as defined in claim 1 wherein the menu is displayable on the plurality of media demodulation devices simultaneously.

9. A method as defined in claim 1 wherein the plurality of media demodulation devices includes a plurality of televisions and the menu is displayed on a screen of at least one of the televisions.

10. A method as defined in claim 1, further comprising:
downloading the information relating to the media content on the remote source to the media unit in advance of displaying the menu.

11. A method as defined in claim 1 wherein the media unit includes a plurality of local media files for selective distribution on the cable infrastructure and the menu includes information relating to the local media files.

12. A method as defined in claim 1 wherein each of the media demodulation devices are tunable to a plurality of channels and displaying the menu on the plurality of channels includes tuning the media demodulation devices to the same channel.

13. A method as defined in claim 1 wherein the menu includes visual features, and wherein interacting with the media unit causes the media unit to change the appearance of at least one of the features of the menu.

14. A method as defined in claim 1 wherein the media content is selected by remotely interacting with the media unit using radio frequency communications.

15. A method as defined in claim 1 wherein the menu aforesaid is a first menu and the plurality of media demodulation devices displaying the first menu are a first plurality of media demodulation devices, the method further comprising:
displaying a second different menu on at least a second media demodulation device.

16. A method as defined in claim 15 wherein the second menu includes information relating to the media content on the remote source that is available for downloading.

17. A method as defined in claim 15 wherein the media unit includes a plurality of local media files for selective distribution on the cable infrastructure and the second menu includes information related to the local media files.

18. A method as defined in claim 1 wherein each of the media demodulation devices are tunable to a plurality of channels and displaying the first menu on the first plurality of channels includes tuning the media demodulation devices to a first channel, and displaying the second menu on the second media demodulation device includes tuning the second media demodulation device to a second, different channel.

19. A media unit for loading media content from a remote source and for selective distribution on a cable infrastructure to a plurality of media demodulation devices connected to the cable infrastructure, the media unit comprising:
a cable infrastructure connector for connecting the media unit to the cable infrastructure;
a remote source connector device for connecting the media unit to the remote source using only a single connection;
a menu generator for generating a menu which includes information relating to the media content available for downloading from the remote source, the menu generator distributing the menu to the plurality of media demodulation devices on the cable infrastructure in a format which enables the media demodulation devices to display the menu;
a memory device for storing local media files;
a control section for receiving input from a user to select at least some of the available media content from the menu for downloading from the remote source;
a communication section connected to the remote source connector device for receiving one or more commands from the control section and for communicating with the remote source through the remote source connector device to identify the selected media content and for downloading the selected media content to the memory device as local media files; and
a media content stream generator connected to the cable infrastructure connector for generating a plurality of simultaneous streams of media content from local media files from the memory device based on user input to be distributed on the cable infrastructure to the plurality of media demodulation devices for reproduction on the plurality of media demodulation devices.

20. A media unit as defined in claim 19 wherein the stream generator generates at least one of the streams from media content downloaded from the remote source.

21. A media unit as defined in claim 19 wherein the remote source connector device is a DSL modem.

22. A media unit as defined in claim 19 wherein the remote source connector device is a cable modem.

23. A media unit as defined in claim 19 wherein the remote source connector device is an Ethernet adaptor.

24. A media unit as defined in claim 19 wherein the remote source connector device is a satellite dish.

25. A media unit as defined in claim 19 wherein the remote source connector device is a universal serial bus adaptor.

26. A media unit as defined in claim 19 wherein the remote source connector device is a wireless wide area network adaptor.

27. A media unit as defined in claim 19 wherein the remote source connector device connects through a single coaxial cable.

28. A media unit as defined in claim 19 wherein the menu generator simultaneously generates and distributes a plurality of menus on the cable infrastructure to the plurality of demodulation devices.

29. A media unit as defined in claim 28 wherein at least two of the menus are different from one another.

30. A media unit as defined in claim 19 wherein the plurality of media demodulation devices includes a plurality of televisions and the menu generator formats the menu to allow the televisions to display the menu.

31. A media unit as defined in claim 19 wherein the communication section downloads information relating to media content available for download from the remote source in advance of the menu generator generating the menu.

32. A media unit as defined in claim 19 wherein the memory device stores a plurality of local media files for selective distribution on the cable infrastructure and the menu includes information relating to the local media files on the memory device.

33. A media unit as defined in claim 19 wherein the media demodulation devices are tunable to receive and demodulate a plurality of channels and the menu generator generates and distributes the menu as a channel.

34. A media unit as defined in claim 33 wherein the menu generator generates and distributes a plurality of menus as channels.

35. A media unit as defined in claim 19 further comprising:
a remote control for communicating with the control section and at least one of the media demodulation devices for transmitting input from the user to the control section to select the media content for downloading.

36. A media unit as defined in claim 35 wherein the remote control includes a radio frequency control portion for communicating with the control section and an infrared section for communicating with the media demodulation device.

37. In a media system for storing media content and distributing media content through a cable infrastructure in a building, where the building cable infrastructure is connected to a channel service with a feed which transmits service channels from the channel service to the building cable infrastructure, and the service channels including service modulated channels that are each modulated with a stream of service media content from the channel service and service unmodulated channels that are not modulated with a stream of service media content, the building cable infrastructure distributing the service channels through a set of legs of the building cable infrastructure to media demodulation devices positioned in the building, and the media system including a media unit which modulates service unmodulated channels with a local content stream to create a local modulated channel and combines the local modulated channel with the service modulated channels on the building cable infrastructure to allow at least one of the media demodulation devices to receive the local modulated channel and to demodulate the local modulated channel to reproduce the local content stream, and having a remote control including an infrared control portion for communicating with and controlling at least one of the media demodulation devices using infrared light and a radio frequency control portion for communicating with and controlling the media unit using a wireless radio frequency communication, a method for selecting a media file from a source remote to the building and for storing the selected media file on the media unit, said method comprising:
connecting the media unit to the remote source of media files through a single connection;
generating an interactive menu as a local menu content stream at the media unit;
modulating at least one of the service unmodulated channels with the interactive menu to create the local modulated channel on the cable infrastructure;
demodulating the local modulated channel with at least one of the media demodulation devices to reproduce the interactive menu; and
communicating between the remote control and the media unit with the radio frequency control portion in response to user interaction with the interactive menu to select a media file from the remote source and to cause the media unit to store the selected media file.

38. A method as defined in claim 37 wherein connecting the media unit to the remote source of media files includes connecting through a cable using a cable modem.

39. A method as defined in claim 37 wherein connecting the media unit to the remote source of media files includes connecting through a telephone line.

40. A method as defined in claim 37 wherein connecting the media unit to the remote source of media files includes connecting to an internet connection.

41. A method as defined in claim 37 further comprising:
communicating between the remote control and the media unit with the radio frequency control portion to interact with the interactive menu to cause the media unit to produce the local menu content stream.

42. A media system for selecting and downloading a media file from a source remote to a building housing the media system and for storing the media file and distributing media content through a cable infrastructure in the building, where the cable infrastructure is connected to a channel service with a feed which transmits service channels from the channel service to the building cable infrastructure, and the service channels including service modulated channels that are each modulated with a stream of service media content from the channel service and service unmodulated channels that are not modulated with a stream of service media content, the building cable infrastructure distributing the service channels through a set of legs of the building cable infrastructure to media demodulation devices positioned in the building, the media system comprising:
a media unit which modulates service unmodulated channels with local content streams to create a plurality of local modulated channels which can be demodulated and reproduced by the media demodulation devices, the media unit further comprising:
a remote source connector device for connecting the media unit to the remote source of media files;
a menu generator for generating a menu which includes a list of at least some media files on the remote source, the menu generator distributing the menu to the plurality of media demodulation devices on the cable infrastructure in a format which enables the media demodulation devices to display the menu;
a memory device for storing local media files;
a control section for receiving a user input from a user to select the media file from the menu for downloading from the remote source;
a communication section connected to the remote source connector device for receiving commands from the control section and for communicating with the remote source through the remote source connector device to identify the media file for downloading based on the user selection and for downloading the selected media file to the memory device through the remote source connector device; and
a media content stream generator for generating a plurality of simultaneous media content streams from local media files stored on the memory device; and
a modulation section for generating a plurality of simultaneous local modulated channels from the plurality of media content streams for distribution of the local modulated channels on the cable infrastructure to allow reproduction of the media content streams on a plurality of the media demodulation devices, the media system further comprising:
a combiner for connecting the media unit with the cable infrastructure to combine the local modulated channels with the service channels on the building cable infrastructure to allow at least one of the media demodulation devices to receive the local modulated channels; and
a remote control including an infrared control portion for communicating with and controlling at least one of the media demodulation devices using infrared light and a radio frequency control portion for communicating with and controlling the media unit using wireless radio frequency communication for transmitting the user input to the control section to identify the media file.

43. A media system as defined in claim 42 wherein the remote source connector device is a cable modem.

44. A media system as defined in claim 42 wherein the remote source connector device is a DSL modem.

45. A media system as defined in claim 42 wherein the remote source connector device is an Ethernet adaptor.

46. A media system as defined in claim 42 wherein the remote source connector device is a wireless wide area network.

47. A media system as defined in claim 42 wherein the remote source connector device is a universal serial bus adaptor.

48. In a media system for storing media content and distributing media content through a cable infrastructure in a building, where the building cable infrastructure is connected to a channel service with a feed which transmits service channels from the channel service to the building cable infrastructure, and the service channels include service modulated channels that are each modulated with a stream of service media content from the channel service and service unmodulated channels that are not modulated with a stream of service media content, the building cable infrastructure distributing the service channels through a set of legs of the building cable infrastructure to media demodulation devices positioned in the building, and the media system including a media unit which modulates service unmodulated channels with at least one local content stream to create at least one local modulated channel and combines the local modulated channel with the service channels on the building cable infrastructure to allow at least one of the media demodulation devices to receive the local modulated channel and to demodulate the local modulated channel to reproduce the local content stream, and having a plurality of remote controls each including an infrared control portion for communicating with and controlling at least one of the media demodulation devices using infrared light and a radio frequency control portion for communicating with and controlling the media unit using wireless radio frequency communication, a method for reproducing a media file stored on the media unit comprising:
generating a plurality of different interactive menus at the media unit;
modulating a plurality of separate service unmodulated channels with the menus to create a plurality of local modulated channels on the cable infrastructure;
demodulating the local modulated channels with a plurality of the media demodulation devices to reproduce the menus on the media demodulation devices;
accepting user selections with any of the remote controls, which user selections are based on one of the interactive menus reproduced on one of the media demodulation devices to select media files;
communicating between each of the remote controls and the media unit with the radio frequency control portions of the remote controls to identify the media files based on the user selection;
generating a plurality of local media content streams based on the identified media files;
modulating the identified media file content streams to create the plurality of local modulated channels on the cable infrastructure; and
demodulating the selected media file content streams with the media demodulation devices to reproduce the identified media files.

49. A media system for storing media content and distributing media content through a cable infrastructure in a building, where the building cable infrastructure is connected to a channel service with a feed which transmits service channels from the channel service to the building cable infrastructure, and the service channels include service modulated channels that are each modulated with a stream of service media content from the channel service and service unmodulated channels that are not modulated with a stream of service media content, the building cable infrastructure distributing the service channels through a set of legs of the building cable infrastructure to media demodulation devices positioned in the building, the media system comprising:
a media unit for modulating service unmodulated channels with local content streams to create local modulated channels;
a combiner for combining the local modulated channels with the service modulated channels on the building cable infrastructure to allow at least one of the media demodulation devices to receive at least one of the local modulated channels and to demodulate the local modulated channel to reproduce the local content stream; and
a plurality of remote controls each including an infrared control portion for communicating with and controlling at least one of the media demodulation devices using infrared light and a radio frequency control portion for communicating with and controlling the media unit using wireless radio frequency communications, wherein the media unit further comprises:
a menu generator for generating a plurality of different interactive menus at the media unit and distributing the menus on the cable infrastructure as local modulated channels; and
a control section for communicating with the plurality of remote controls using the wireless radio frequency communication and for accepting user selections from each of the remote controls, which user selections are based on one of the interactive menus reproduced on one of the media demodulation devices to identify media files for modulating as local content streams onto local channels.

50. In a media system which includes a media unit for generating menu and media content streams for distribution as local modulated channels to a plurality of media demodulation devices over a cable infrastructure and which includes a plurality of remote controls for user control over the content streams, where the remote controls transmit control code sequences to the media unit to control the content streams and the remote controls each include local channel buttons which each receive user interaction to cause the media demodulation devices to tune to a corresponding local modulated channel to display the content stream on the corresponding local modulated channel, a method for identifying which remote control controls which content stream, comprising:
transmitting the control code sequence from the selected remote control with a portion that identifies which local channel button was last pressed on the selected remote control to identify which content stream is to be controlled by the selected remote control.
